(19) United States
(12) Patent Application Publication
(10) Pub. No.: US 2023/0037790 A1
(43) Pub. Date: Feb. 9, 2023

(54) GREEN ELECTROLYTES FOR ELECTROCHEMICAL ENERGY STORAGE

(71) Applicant: Uchicago Argonne, LLC, Chicago, IL (US)

(72) Inventors: Zhengcheng Zhang, Naperville, IL (US); Noah Mark Johnson, Chicago, IL (US)

(73) Assignee: Uchicago Argonne, LLC, Chicago, IL (US)

(21) Appl. No.: 17/857,469

(22) Filed: Jul. 5, 2022

Related U.S. Application Data
(60) Provisional application No. 63/218,779, filed on Jul. 6, 2021.

(51) Int. Cl. H01M 10/0569; H01M 10/0525

(52) U.S. Cl. CPC H01M 10/0569; H01M 10/0525; H01M 2300/0034; H01M 2004/028

(57) ABSTRACT

Described herein are isosorbide-based electrolytes that are inexpensive, commercially available, green, and safe electrolytes. These electrolytes include a lithium salt, a solvent represented as a compound of Formula I, and optionally, a diluent. Such electrolytes have greatly enhanced cycle and calendar life when used with Si anodes, and exhibit very low leakage currents when compared to standard carbonate-based electrolytes.

### CROSS REFERENCE TO RELATED APPLICATIONS

This application claims the benefit of priority to U.S. Provisional Patent Application No. 63/218,779 filed Jul. 6, 2021, which is hereby incorporated by reference, in its entirety for any and all purposes.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is related to the green electrolytes that are used in electrochemical energy storage. In particular, the present technology describes isosorbide-based electrolytes.

### BACKGROUND

Lithium-ion batteries (LIBs) are one of the most prominent forms of electrochemical energy storage. Their high energy density, long lifespan, and broad voltage range has enabled applications in technology ranging from toys to satellites. However, as the world transitions to a greener ecosystem, the range of technologies that utilize electrochemical energy storage will need to increase, and the current LIBs are insufficient to the task.

One promising new candidate for LIBs is the silicon (Si) anode. Si has a much higher specific capacity (3579 mAh/g) than the current state-of-the-art anode, graphite (372 mAh/g). As well, Si is more resistant to lithium dendrite formation, and is a very common element in the earth's crust. However, it suffers from a severe weakness in a lack of passivation. While graphite can reliably form a stable surface-electrolyte interphase (SEI) that prevents future reactivity with the lithiated anode, Si experiences 4859-6701-8279 continual reactivity. This is due to both a 300% volume expansion that disrupts the SEI surface, as well as an inherent instability, which can be seen even on flat silicon surfaces.

The most common electrolytes are ethylene carbonate (EC), ethyl methyl carbonate (EMC), and dimethyl carbonate (DMC), but these materials are commonly synthesized using petroleum products and thus, limit the ability of transitioning electrochemical energy storage away from fossil fuels. Additives such as fluoroethylene carbonate (FEC) or vinylene carbonate (VC) can improve the cycle and calendar life of silicon-based anodes, but only proportionally to the concentration of these materials, as they are continuously consumed during operation. Better results are obtained with alternative solvent systems, such as ionic liquids or ethers, but these have practical limitations such as small voltage windows or prohibitive cost.

### SUMMARY

In one aspect is an electrolyte including:
(a) a lithium salt; and
(b) a solvent represented as a compound of Formula I:

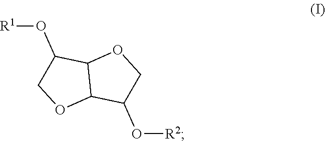

wherein,
R¹ and R² are each independently alkyl, haloalkyl, cycloalkyl, aryl, heteroaryl, aralkyl, heteroaralkyl, -L¹-OR³, —(C═O)—R⁴, —SO₂-R⁵, or —SO₂—OR⁵;
L¹ is alkylene; and
R³, R⁴, and R⁵ are each independently alkyl, haloalkyl, cycloalkyl, aryl, heteroaryl, aralkyl, or heteroaralkyl; and
(c) optionally, a diluent.

In some embodiments, R¹ and R² are each independently alkyl, haloalkyl, aryl, heteroaryl, —(C═O)—R⁴, or —SO₂—OR⁵. In some embodiments, R³, R⁴, and R⁵ are each independently alkyl or haloalkyl.

In some embodiments, R¹ and R² are each independently —CH₃, —CH₂CH₃, —CH₂CH₂CH₃, —CH₂CH₂CH₂CH₃, —CH(CH₃)₂, —C(CH₃)₃, —CF₃, —CH₂CF₃, —CF₂CF₃, or —CF₂CHF₂. In some embodiments, R¹ and R² are not both —CH₃.

In some embodiments, R¹ and R² are each independently -(L¹)-OCH₃, -(L¹)-OCH₂CH₃, -(L¹)-OCH₂CH₂CH₃, -(L¹)-OCH₂CH₂CH₂CH₃, -(L¹)-OCH(CH₃)₂, -(L¹)-OC(CH₃)₃, -(L¹)-OCF₃, -(L¹)-OCH₂CF₃, -(L¹)-OCF₂CF₃, or -(L¹)-OCF₂CHF₂. In some embodiments, L¹ is —CH₂—, —CH₂CH₂—, —CH₂CH₂CH₂— or —CH₂CH₂CH₂CH₂—.

In some embodiments, R¹ and R² are each independently —(C═O)—CH₃, —(C═O)—CH₂CH₃, —(C═O)—CH₂CH₂CH₃, —(C═O)—CH₂CH₂CH₂CH₃, —(C═O)—CH(CH₃)₂, —(C═O)—C(CH₃)₃, —(C═O)—CF₃, —(C═O)—CH₂CF₃, —(C═O)—CF₂CF₃, or —(C═O)—CF₂CHF₂.

In some embodiments, R¹ and R² are each independently —(SO₂)—OCH₃, —(SO₂)—OCH₂CH₃, —(SO₂)—OCH₂CH₂CH₃, —(SO₂)—OCH₂CH₂CH₂CH₃, —(SO₂)—OCH(CH₃)₂, —(SO₂)—OC(CH₃)₃, —(SO₂)—OCF₃, —(SO₂)—OCH₂CF₃, —(SO₂)—OCF₂CF₃, or —(SO₂)—OCF₂CHF₂.

In some embodiments, R¹ and R² are each independently phenyl, 2-pyridyl, 3-pyridyl, 4-pyridyl, 2-thienyl, 3-thienyl, 2-furyl, 3-furyl, 2-pyrrolyl, or 3-pyrrolyl.

In some embodiments, the solvent is a compound selected from the group consisting of:

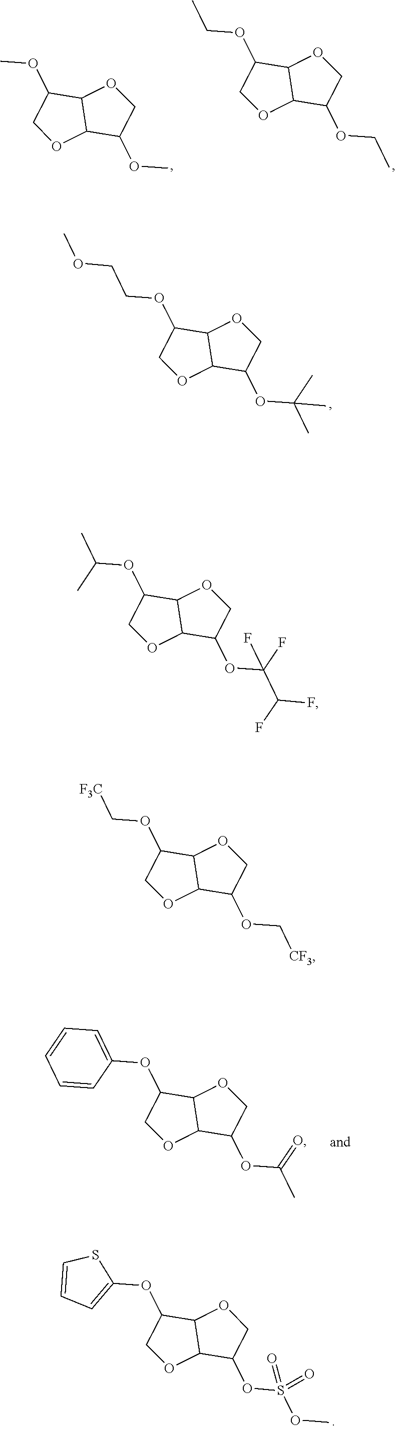

In some embodiments, the lithium salt includes LiClO₄, LiPF₆, LiAsF₆, LiBF₄, LiB(C₂O₄)₂ (LiBOB), LiBF₂(C₂O₄) (LiDFOB), LiCF₃SO₃, LiN(SO₂F)₂ (LiFSI), LiPF₃(C₂F₅)₃ (LiFAP), LiPF₄(CF₃)₂, LiPF₃(CF₃)₃, LiN(SO₂CF₃), LiCF₃CO₂, LiC₂F₅CO₂, LiPF₂(C₂O₄)₂ (LiDFOP), LiP(C₂O₄)₃ (LiTOP), LiPF₄C₂O₄ (LiTFOP), LiPF₄(C₄H₂O₄) (LiTFMP), LiBF₂(C₄H₂O₄)₂ (LiDFMP), LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10. In some embodiments, the lithium salt includes LiPF₆, LiDFOB, LiFSI, or a mixture of any two or more thereof.

In some embodiments, the lithium salt is present in the electrolyte in a concentration of from about 0.01 M to about 5 M or from about 0.01 M to about 1.5 M.

In some embodiments, the diluent includes a fluorinated ether-based diluent, an ether-based diluent, a nitrile-based diluent, or a mixture of any two or more.

In some embodiments, the fluorinated ether-based diluent includes 1,1,2,2-tetrafluoroethyl-2,2,3,3-tetrafluoropropyl ether (TTE), 1,2-(1,1,2,2-tetrafluoroethoxy)ethane (TFEE), 1,1,1-trifluoroethyl-2,2,3,3-tetrafluoropropyl ether (TFTFE), bis-(trifluoroethyl) ether (BTFE), 1,1,2,2-tetrafluoroethyl-2,2,3,3,3-pentafluoropropyl ether; 2,2,2-trisfluoroethyl-1,1,2,3,3,3-hexafluoropropyl ether, ethyl-1,1,2,3,3,3-hexafluoropropyl ether, difluoromethyl-2,2,3,3,3-pentafluoropropyl ether, difluoromethyl-2,2,3,3-tetrafluoropropyl ether; 2-fluoro-1,3-dioxolane, 2,2-difluoro-1,3-dioxolane; 2-trifluoromethyl-1,3-dioxolane, 2,2-bis(trifluoromethyl)-1,3-dioxolane, 4-fluoro-1,3-dioxolane, 4,5-difluoro-1,3-dioxolane, or a mixture of any two or more thereof. In some embodiments, the fluorinated ether-based diluent includes 1,1,2,2-tetrafluoroethyl-2,2,3,3-tetrafluoropropyl ether (TTE), 1,2-(1,1,2,2-tetrafluoroethoxy)ethane (TFEE), 1,1,1-trifluoroethyl-2,2,3,3-tetrafluoropropyl ether (TFTFE), bis-(trifluoroethyl) ether (BTFE), or a mixture of any two or more thereof. In some embodiments, the fluorinated ether-based diluent includes 1,1,2,2-tetrafluoroethyl-2,2,3,3-tetrafluoropropyl ether (TTE).

In some embodiments, the ether-based diluent includes 1,3-dioxolane (DOL), dimethoxyethane (DME), tetrahydrofuran, di(ethylene glycol) dimethyl ether, tri(ethylene glycol) dimethyl ether, diglyme (DGM), partly silanized ether, tetra(ethylene glycol) dimethyl ether (TEGDME), poly (ethylene glycol) dimethyl ether (PEGDME), 1,4-dioxane, or a mixture of any two or more thereof.

In some embodiments, the diluent includes butanenitrile (BN).

In some embodiments, the diluent further includes a carbonated-based diluent, a fluorinated carbonate-based diluent, or a mixture of any two or more thereof.

In some embodiments, the carbonated-based diluent includes ethylene carbonate, dimethyl carbonate, ethyl methyl carbonate, diethyl carbonate, propylene carbonate, fluorinated carbonate, or a mixture of any two or more thereof.

In some embodiments, the fluorinated carbonated-based diluent includes fluoroethylene carbonate (FEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, or a mixture of any two or more thereof.

In some embodiments, the diluent does not include a carbonated-based diluent, a fluorinated carbonated-based diluent, or a mixture of any two or more thereof.

In some embodiments, the diluent is present in the electrolyte in a solvent to diluent ratio of from about 50:50 to about 90:10, from about 50:50 to about 80:10, or from about 50:50 to about 75:25.

In some embodiments, the electrolyte further includes a stabilizing additive. In some embodiments, the stabilizing additive includes a N—O compound, polysulfide, phosphorus pentasulfide, fumaronitrile, ethyl 3,3,3-trifluoropropanoate (TFPE), vinylene carbonate (VC), fluoroethylene carbonate (FEC), ethylene sulfite (ES), p-toluenesulfonyl isocyanate (PSTI), triethylborate (TEB), tris(trimethylsilyl)borate(TMSB), tris(trimethylsilyl)phosphite (TMSPi), tris(2,2,2-trifluoroethyl)phosphite (TTFPi), tris(trimethylsilyl)borate (TMSB), phenyl vinyl sulfone (PVS), ethylene glycol bis(propionitrile)ether (EGBE), terthiophene (3THP), quercetin (Qc), or a mixture of any two or more thereof.

In some embodiments, the electrolyte further includes an additive including LiDFOB (lithium difluoro(oxalato)borate), LiDFMB (lithium difluoro(maleic)borate), LiBOB (lithium bis(oxalato)borate, LiTFOP (lithium tetrafluoro(oxalato)phosphate, LiTFMP (lithium tetrafluoro(maleic)phosphate LiDFOP (lithium difluoro-bis(oxalato)phosphate, LiTOP (lithium tri(oxalato)phosphate, or a mixture of any two or more thereof. In some embodiments, the electrolyte further includes LiDFOB (lithium difluoro(oxalato)borate).

Also provided in another aspect is an electrochemical device including:
(a) a cathode;
(b) an anode; and
(c) any one of the electrolytes described herein.

In some embodiments, the electrochemical device is a lithium or sodium secondary battery. In some embodiments, the secondary battery is a lithium battery, a lithium-ion battery, a lithium-sulfur battery, a lithium-air battery, a sodium ion battery, or a magnesium battery.

In some embodiments, the cathode comprises a layered lithium nickel cobalt manganese oxide, spinel lithium nickel manganese oxide, lithium iron phosphate, lithium cobalt oxide, lithium nickel oxide, lithium manganese oxide, or a mixture of any two of more thereof. In some embodiments, the cathode comprises lithium iron phosphate. In some embodiments, the cathode comprises layered lithium nickel cobalt manganese oxide, spinel lithium nickel manganese oxide, or a mixture of any two of more thereof.

In some embodiments, the anode comprises lithium metal, graphitic materials, amorphous carbon, Li₄Ti₅O₁₂, tin alloys, silicon or silicon alloys, intermetallic compounds, or mixtures of any two or more such materials. In some embodiments, the anode comprises silicon or silicon alloys.

In some embodiments, the anode and cathode are separated from each other by a porous separator.

### BRIEF DESCRIPTION OF THE DRAWINGS

FIGS. 1A and 1B illustrate the differential capacity curves of the first formation cycle for different electrolyte species: Gen 2+3% fluoroethylene carbonate (FEC), isosorbide dimethyl ether (IDE)+1 M LiPF₆, and IDE+1 M LiFSI, according to the examples. FIG. 1A shows the solid electrolyte interphase (SEI) formation events (FIG. 1A) while FIG. 1B shows the lithiation profile (FIG. 1B). Gen 2 contains 1.2 M LiPF₆ in 3:7 ethylene carbonate/ethyl methyl carbonate.

FIG. 2A illustrates the change in viscosity with concentration of IDE in IDE/TTE electrolytes in 1 M of LiFSI, according to the examples. TTE=1,1,2,2-tetrafluoroethyl-2,2,3,3-tetrafluoropropyl ether.

FIG. 2B illustrates the specific capacity and Coulombic efficiency of IDE/TTE electrolytes (IDE+1 M LiFSI, IDE/TTE (75/25)+1 M LiFSI, IDE/TTE (50/50)+1 M LiFSI, and IDE/TTE (25/75)+1 M LiFSI) and on silicon anodes with lithium iron phosphate (LFP) cathodes, according to the examples. The comparative electrolyte used in this study was Gen 2, which contains 1.2M LiPF₆ in 3:7 ethylene carbonate/ethyl methyl carbonate, with 3% w/w of fluoroethylene carbonate (FEC).

FIG. 3A shows a Nyquist plot comparing cells with a carbonate-based electrolytes (Gen 2 containing 1.2 M LiPF₆ in 3:7 ethylene carbonate/ethyl methyl carbonate with 3% w/w of fluoroethylene carbonate (FEC)) and an IDE-based electrolyte (IDE/TTE (25/75)+1 M LiFSI) after formation cycles, and after aging cycles, according to the examples.

FIG. 3B illustrates the difference between average charge and discharge voltage for different electrolytes (IDE+1 M LiFSI, IDE/TTE (75/25)+1 M LiFSI, IDE/TTE (50/50)+1 M LiFSI, and IDE/TTE (25/75)+1 M LiFSI) during aging cycles of silicon anodes with lithium iron phosphate (LFP) cathodes, according to the examples. The comparative electrolyte was Gen 2, which contains 1.2 M LiPF₆ in 3:7 ethylene carbonate/ethyl methyl carbonate, with 3% w/w of fluoroethylene carbonate (FEC).

FIG. 4A shows the differential capacity curves of silicon anodes with lithium iron phosphate (LFP) cathodes for different electrolytes: IDE/TTE (25/75)+1 M LiFSI, IDE/TFTFE (50/50)+1 M LiFSI, IDE/BTFE (50/50)+1 M LiFSI, IDE/TFEE (50/50)+1 M LiFSI), according to the examples. The comparative electrolyte used in this study was Gen 2, which contains 1.2 M LiPF₆ in 3:7 ethylene carbonate/ethyl methyl carbonate, with 3% w/w of fluoroethylene carbonate (FEC). TFEE=1,2-(1,1,2,2-tetrafluoroethoxy)ethane, TFTFE=1,1,1-trifluoroethyl-2,2,3,3-tetrafluoropropyl ether, and bis-(trifluoroethyl) ether (BTFE).

FIG. 4B shows the specific capacities and Coulombic efficiencies of silicon anodes with lithium iron phosphate (LFP) cathodes for electrolytes as described in FIG. 4A.

FIG. 5 shows the specific capacities and Coulombic efficiencies after extended cycling of silicon anodes with lithium iron phosphate (LFP) cathodes for different electrolytes: IDE/TTE (25/75)+1 M LiFSI, IDE/TFTFE (50/50)+1 M LiFSI, IDE/BTFE (50/50)+1 M LiFSI, and 1 M LiFSI, IDE/TFEE (50/50)+1 M LiFSI, according to the examples. The comparative electrolyte used in this study was Gen 2, which contains 1.2 M LiPF₆ in 3:7 ethylene carbonate/ethyl methyl carbonate, with 3% w/w of fluoroethylene carbonate (FEC).

FIG. 6 shows the specific capacities and Coulombic efficiencies of silicon anodes with LiNi_{0.8}Mn_{0.1}Co_{0.1}O₂ (NMC811) cathodes for different electrolytes: IDE/DME/FEC (40/40/20)+1 M LiPF₆, IDE/BN/FEC/(70/20/10)+1 M LiPF₆, IDE/BTFE (50/50)+1 M LiFSI+0.1 M LiPF₆, IDE/TTE (75/25)+1 M LiFSI+0.1 M LiPF₆, and IDE/TTE (75/25)+0.5 M LiFSI+0.5 M LiPF₆, according to the examples. The comparative electrolyte used in this study was Gen 2, which contains 1.2 M LiPF₆ in 3:7 ethylene carbonate/ethyl methyl carbonate, with 3% w/w of fluoroethylene carbonate (FEC). BN=butanenitrile, and DME=dimethoxyethane.

FIG. 7 shows the specific capacities and Coulombic efficiencies of silicon anodes with LiNi_{0.8}Mn_{0.1}Co_{0.1}O₂ (NMC811) cathodes for different electrolytes: IDE/TTE (20/80)+1 M LiFSI+0.1 M LiPF₆ with stainless steel-free (SS) set up and IDE/TTE (20/80)+1 M LiFSI+0.1 M LiPF₆ with Al-clad cap, according to the examples.

FIG. 8 shows the specific capacities and Coulombic efficiencies of silicon anodes with LiNi_{0.8}Mn_{0.1}Co_{0.1}O₂ (NMC811) cathodes for different electrolytes: IDE/TTE (20/80)+1 M LiFSI+0.1 M LiPF₆, IDE/TTE (20/80)+1 M LiFSI+0.1 M LiPF₆ with Al-clad cap, IDE/TTE (20/80)+1 M LiFSI+0.1 M LiDFOB, and IDE/TTE (20/80)+1 M LiFSI+0.5 M LiDFOB, according to the examples. LiDFOB=Lithium difluoro(oxalato)borate.

FIGS. 9A, 9B, and 9C show graphs of (A) differential capacity of the first formation cycle and (B) specific capacity and Coulombic efficiency of LFP/Si cells and (c) voltage profiles of the first formation cycle for LFP/Si cells containing GenF (1.2 M LiPF6 EC/EMC+3% FEC), 1 M LiPF6 IDE, and 1 M LiFSI IDE electrolytes, according to the examples.

FIG. 10 is a graph of viscosity of IDE/TTE electrolytes containing different ratios of IDE to TTE.

FIGS. 11A and 11B are graphs of (A) differential capacity and (B) specific capacities and Coulombic efficiencies for IDE/HFE electrolytes in comparison to GenF.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Alkyl groups include straight chain and branched chain saturated hydrocarbon groups having from 1 to 14 carbons unless indicated otherwise. For example, a C₁₋₆ alkyl group includes alkyl groups with 1, 2, 3, 4, 5, or 6 carbon atoms. In some embodiments, an alkyl group has from 1 to 12 carbon atoms, from 1 to 10 carbons, from 1 to 8, 1 to 6, or 1, 2, 3 or 4 carbon atoms. Examples of straight chain alkyl groups include groups such as methyl, ethyl, n-propyl, n-butyl, n-pentyl, n-hexyl, n-heptyl, and n-octyl, n-decyl, n-dodecyl and n-tetradecyl groups. Examples of branched chain alkyl groups include, but are not limited to, isopropyl, iso-butyl, sec-butyl, tert-butyl, neopentyl, isopentyl, and 2,2-dimethylpropyl groups. Alkyl groups may be unsubstituted or are optionally substituted with one or more hydroxyl or halogen groups. In some embodiments, an alkyl group is a C₁-C₆ alkyl or C₁-C₄ alkyl group. In some embodiments, an alkyl group is a C₂-C₆ alkyl or C₂-C₆ alkyl group.

Cycloalkyl groups include mono-, bi- or tricyclic alkyl groups having from 3 to 12 carbon atoms in the ring(s), or, in some embodiments, 3 to 10, 3 to 8, or 3, 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Bi- and tricyclic ring systems include both bridged cycloalkyl groups and fused rings, such as, but not limited to, adamantyl, decalinyl, and the like. Cycloalkyl groups may be unsubstituted or substituted as alkyl groups are. In some embodiments, a cycloalkyl group is a C₃-C₁₀ cycloalkyl or C₃-C₆ cycloalkyl group.

Haloalkyl groups include alkyl groups as defined above in which 1 or more of the hydrogen atoms are replaced by a halogen (i.e., F, Cl, Br, or I). In some embodiments, the haloalkyl group bears from 1, 2, 3, 4, 5, 6 or more halogens. In some embodiments, the haloalkyl group bears from 1 to 6 halogens or 1 to 3 halogens. In others, the haloalkyl is perhalogenated such as perfluorinated or perchlorinated. Examples of haloalkyl groups include but are not limited to —CH₂C₁, —CH₂F, —CF₃, —CH₂CH₂Br, and —CH₂CF₃. In some embodiments, a haloalkyl group is a C₁-C₆ haloalkyl or C₁-C₄ haloalkyl group.

Alkylene groups are alkyl groups, as defined herein, which are divalent; i.e., they have two points of attachment to a compound of the present technology. In some embodiments, an alkylene group is a C₁-C₆ alkylene or C₁-C₄ alkylene group.

Aryl groups are cyclic aromatic hydrocarbons containing 6-14 carbon atoms and do not contain heteroatoms. Aryl groups herein include monocyclic, bicyclic and tricyclic ring systems, including fused rings. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain from 6-12 or even 6-10 carbon atoms in the ring portions of the groups. In some embodiments, the aryl groups are phenyl or naphthyl. Aryl groups may also include fused aromatic-aliphatic ring systems, e.g., indanyl, tetrahydronaphthyl, and the like. Aryl groups may be unsubstituted or optionally substituted with one or more alkyl, halo groups or one or more halogens. In some embodiments, the aryl groups are substituted with 1, 2 or 3 alkyl groups and/or 1-5 halogens.

Aralkyl groups are alkyl groups as defined above in which a hydrogen or carbon bond of an alkyl group is replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl, or both the alkyl and aryl portions of the group. Representative aralkyl groups include but are not limited to benzyl and phenethyl groups and fused (cycloalkylaryl)alkyl groups such as 4-indanylethyl. Aralkyl groups may be unsubstituted or substituted. Representative substituted aralkyl groups may be substituted one or more times with alkyl groups or halogens as for aryl and alkyl groups.

Heteroaryl groups are aromatic ring compounds containing 5 or more ring members, of which one or more is a heteroatom selected from N, O, S, and P. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Heteroaryl groups may be unsubstituted or optionally substituted with one or more alky groups or one or more halogens. In some embodiments, the aryl groups are substituted with 1, 2, or 3 alkyl groups and/or 1-5 halogens.

Heteroarylalkyl groups are alkyl groups as defined above in which a hydrogen or carbon bond of an alkyl group is replaced with a bond to a heteroaryl group as defined above. Representative heteroarylalkyl groups include, but are not limited to, furan-2-yl-methyl, imidazol-4-yl-methyl, pyridin-3-yl-methyl, and indol-2-yl-propyl. In some embodiments, the alkyl portion of the heteroarylalkyl group has from 1 to 6 carbon atoms (i.e., 1, 2, 3, 4, 5, or 6). Heteroarylalkyl groups may be unsubstituted or substituted as heteroaryl and alkyl groups are.

A halogen refers to any of fluorine, chlorine, bromine or iodine atoms. A halide is a halogen anion such as F⁻, Cl⁻, Br⁻ or I⁻.

Described herein are electrolytes that are based on isosorbide, such as isosorbide dimethyl ether (IDE). Such electrolytes are an attractive alternative to commonly used carbonate-based electrolytes, such ethylene carbonate (EC), ethyl methyl carbonate (EMC), and dimethyl carbonate (DMC), that are derived from petroleum products. In contrast, the isosorbide electrolytes are produced through the hydrolysis of cellulose, represent a way to add value to biomass refining, and are commercially available. As such, the electrolytes described herein are inexpensive, commercially available, green, and safe electrolytes. Furthermore, as demonstrated herein, these electrolytes have greatly enhanced cycle and calendar life when used with Si anodes, and exhibit very low leakage currents when compared to standard carbonate-based electrolytes.

### Electrolytes

The electrolytes described herein are based on isosorbides, such as isosorbide dimethyl ether (IDE). The isosorbides described herein represent a new class of class of solvents, dianhydrosugars. Anydrosugars and their precursors are synthesized through the hydrolysis of starch, and have generated significant interest as building blocks that can serve as an alternative to petrochemicals. For this reason, they have been designated by the Department of Energy as molecules of special interest and have found use as starting materials for pharmaceuticals, plasticizers, and biopolymers. Furthermore, isosorbides can also be derivatized to form useful solvents with high boiling points, low toxicity, and limited flammability.

In one aspect is an electrolyte including:
(a) a lithium salt; and
(b) a solvent represented as a compound of Formula I:
wherein,

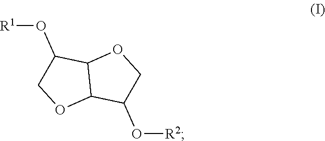

R¹ and R² are each independently alkyl, haloalkyl, cycloalkyl, aryl, heteroaryl, aralkyl, heteroaralkyl, -L¹-OR³, —(C═O)—R⁴, —SO₂-R⁵, or —SO₂—OR⁵;
L¹ is alkylene; and
R³, R⁴, and R⁵ are each independently alkyl, haloalkyl, cycloalkyl, aryl, heteroaryl, aralkyl, or heteroaralkyl; and
(c) optionally, a diluent.

In some embodiments, R³, R⁴, and R⁵ are each independently alkyl, haloalkyl, aryl, or heteroaryl.

In some embodiments, R¹ and R² are each independently alkyl, haloalkyl, cycloalkyl, aryl, heteroaryl, aralkyl, heteroaralkyl, -L¹-OR³, —(C═O)—R⁴, —SO₂-R⁵, or —SO₂—OR⁵. In some embodiments, R¹ and R² are each independently alkyl, haloalkyl, aryl, heteroaryl, -L¹-OR³, —(C═O)—R⁴, or —SO₂—OR⁵. In some embodiments, R³, R⁴, and R⁵ are each independently alkyl or haloalkyl, including C₁₋₆ alkyl, C₁₋₄ alkyl, C₁₋₆ haloalkyl and C₁₋₄ haloalkyl. In some embodiments, R³, R⁴, and R⁵ are each independently alkyl. In some embodiments, R³, R⁴, and R⁵ are each independently haloalkyl.

In some embodiments, R¹ and R² are each independently alkyl, including C₁₋₆ alkyl and C₁₋₄ alkyl. In some embodiments, R¹ and R² are each independently —CH₃, —CH₂CH₃, —CH₂CH₂CH₃, —CH₂CH₂CH₂CH₃, —CH(CH₃)₂, —C(CH₃)₃, —CF₃, —CH₂CF₃, —CF₂CF₃, or —CF₂CHF₂. In some embodiments, R¹ and R² are C₂₋₆ alkyl or C₂₋₄ alkyl. In some embodiments, R¹ and R² are not both —CH₃. In some embodiments, R¹ and R² are not both —CH₃.

In some embodiments, R¹ and R² are each independently -L¹-OR³, L¹ is alkylene, including C₁-C₆ and C₁-C₄ alkylene, and R³ is each independently alkyl or haloalkyl, including C₁₋₆ alkyl, C₁₋₄ alkyl, C₁₋₆ haloalkyl and C₁₋₄ haloalkyl. In some embodiments, R¹ and R² are each independently -(L¹)-OCH₃, -(L¹)-OCH₂CH₃, -(L¹)-OCH₂CH₂CH₃, -(L¹)-OCH₂CH₂CH₂CH₃, -(L¹)-OCH(CH₃)₂, -(L¹)-OC(CH₃)₃, -(L¹)-OCF₃, -(L¹)-OCH₂CF₃, -(L¹)-OCF₂CF₃, or -(L¹)-OCF₂CHF₂. In some embodiments, L¹ is —CH₂—, —CH₂CH₂—, —CH₂CH₂CH₂— or —CH₂CH₂CH₂CH₂—.

In some embodiments, R¹ and R² are each independently —(C═O)—R⁴ and R⁴ is each independently alkyl or haloalkyl, including C₁₋₆ alkyl, C₁₋₄ alkyl, C₁₋₆ haloalkyl and C₁₋₄ haloalkyl. In some embodiments, R¹ and R² are each independently —(C═O)—CH₃, —(C═O)—CH₂CH₃, —(C═O)—CH₂CH₂CH₃, —(C═O)—CH₂CH₂CH₂CH₃, —(C═O)—CH(CH₃)₂, —(C═O)—C(CH₃)₃, —(C═O)—CF₃, —(C═O)—CH₂CF₃, —(C═O)—CF₂CF₃, or —(C═O)—CF₂CHF₂.

In some embodiments, R¹ and R² are each independently —(SO₂)—R⁵ and R⁵ is each independently alkyl or haloalkyl, including C₁₋₆ alkyl, C₁₋₄ alkyl, C₁₋₆ haloalkyl and C₁₋₄ haloalkyl. In some embodiments, R¹ and R² are each independently —(SO₂)—OCH₃, —(SO₂)—OCH₂CH₃, —(SO₂)—OCH₂CH₂CH₃, —(SO₂)—OCH₂CH₂CH₂CH₃, —(SO₂)—OCH(CH₃)₂, —(SO₂)—OC(CH₃)₃, —(SO₂)—OCF₃, —(SO₂)—OCH₂CF₃, —(SO₂)—OCF₂CF₃, or —(SO₂)—OCF₂CHF₂.

In some embodiments, R¹ and R² are each independently aryl or heteroaryl. In some embodiments, R¹ and R² are each independently phenyl, 2-pyridyl, 3-pyridyl, 4-pyridyl, 2-thienyl, 3-thienyl, 2-furyl, 3-furyl, 2-pyrrolyl, or 3-pyrrolyl. In some embodiments, R¹ and R² are each independently phenyl. In some embodiments, R1 and R² are each independently 2-pyridyl, 3-pyridyl, 4-pyridyl, 2-thienyl, 3-thienyl, 2-furyl, 3-furyl, 2-pyrrolyl, or 3-pyrrolyl.

In some embodiments, the solvent is a compound selected from the group consisting of:

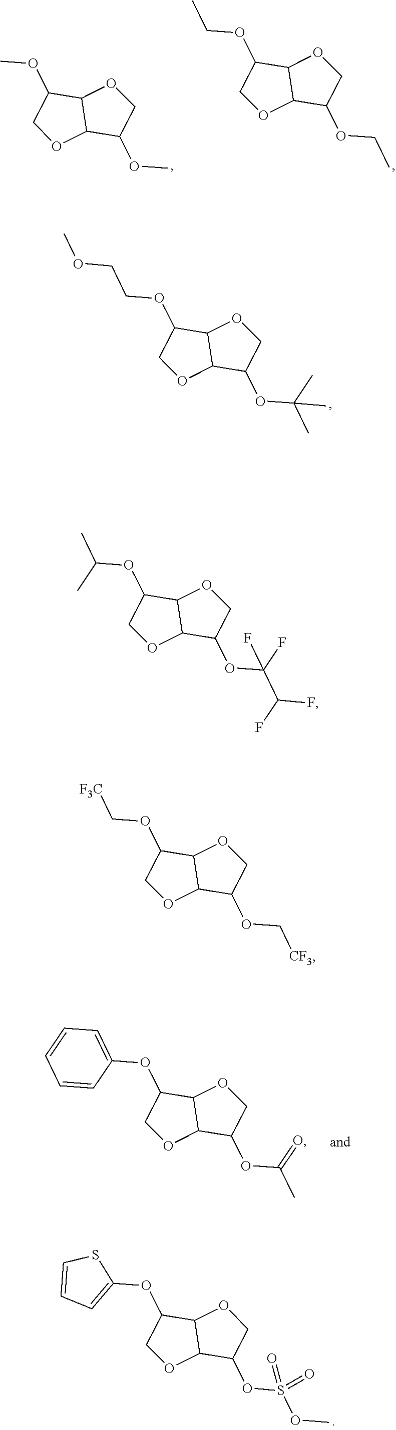

In some embodiments, the lithium salt includes LiClO₄, LiPF₆, LiAsF₆, LiBF₄, LiB(C₂O₄)₂ (LiBOB), LiBF₂(C₂O₄) (LiDFOB), LiCF₃SO₃, LiN(SO₂F)₂ (LiFSI), LiPF₃(C₂F₅)₃ (LiFAP), LiPF₄(CF₃)₂, LiPF₃(CF₃)₃, LiN(SO₂CF₃), LiCF₃CO₂, LiC₂F₅CO₂, LiPF₂(C₂O₄)₂ (LiDFOP), LiP(C₂O₄)₃ (LiTOP), LiPF₄C₂O₄ (LiTFOP), LiPF₄(C₄H₂O₄) (LiTFMP), LiBF₂(C₄H₂O₄)₂ (LiDFMP), LiN(CF₃SO₂)₂, LiC(CF₃SO₂)₃, LiN(SO₂C₂F₅)₂, a lithium alkyl fluorophosphate, Li₂B₁₂X_{12-α}H_{α}, L₁₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10. In some embodiments, the lithium salt includes LiClO₄, LiPF₆, LiAsF₆, LiBF₄, LiB(C₂O₄)₂ (LiBOB), LiBF₂(C₂O₄) (LiDFOB), LiCF₃SO₃, LiN(SO₂F)₂ (LiFSI), LiPF₃(C₂F₅)₃ (LiFAP), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10. In some embodiments, the lithium salt includes LiPF₆, LiDFOB, LiFSI, or a mixture of any two or more thereof. In some embodiments, the lithium salt includes LiFSI. In some embodiments, the lithium salt includes LiPF₆ and LiFSI. In some embodiments, the lithium salt includes LiDFOB and LiFSI.

In some embodiments, the lithium salt is present in the electrolyte in a concentration of from about 0.01 M to about 5 M or from about 0.01 M to about 1.5 M, including about 0.01 M, about 0.05 M, about 0.1 M, about 0.2 M, about 0.3 M, about 0.4 M, about 0.5 M, about 0.6 M, about 0.7 M, about 0.8 M, about 0.9 M, about 1.0 M, about 1.5 M, about 2.0 M, about 2.5 M, about 3.0 M, about 3.5 M, about 4.0 M, about 4.5 M, and 5.0 M. In some embodiments, the lithium salt is present in the electrolyte in a concentration of from about 0.01 M to about 5 M. In some embodiments, the lithium salt is present in the electrolyte in a concentration of from about 0.01 M to about 1.5 M. In some embodiments, the lithium salt is present in the electrolyte in a concentration of from about 0.1 M to about 1.5 M.

The electrolytes described herein may further comprise a diluent. In some embodiments, a diluent is a low-viscosity diluent that may be also be a small molecule compound that improves conductivity. In some instances, the electrolytes including a compound of Formula I as described herein may be highly viscous, and the additional of a diluent alleviates the highly viscous nature of the electrolytes. In some embodiments, the diluent includes a fluorinated ether-based diluent, an ether-based diluent, a nitrile-based diluent, or a mixture of any two or more.

Illustrative fluorinated ether-based diluents include, but are not limited to, 1,1,2,2-tetrafluoroethyl-2,2,3,3-tetrafluoropropyl ether (TTE), 1,2-(1,1,2,2-tetrafluoroethoxy)ethane (TFEE), 1,1,1-trifluoroethyl-2,2,3,3-tetrafluoropropyl ether (TFTFE), bis-(trifluoroethyl) ether (BTFE), 1,1,2,2-tetrafluoroethyl-2,2,3,3,3-pentafluoropropyl ether, 2,2,2-trisfluoroethyl-1,1,2,3,3,3-hexafluoropropyl ether, ethyl-1,1,2,3,3,3-hexafluoropropyl ether, difluoromethyl-2,2,3,3,3-pentafluoropropyl ether, difluoromethyl-2,2,3,3-tetrafluoropropyl ether, 2-fluoro-1,3-dioxolane, 2,2-difluoro-1,3-dioxolane; 2-trifluoromethyl-1,3-dioxolane, 2,2-bis(trifluoromethyl)-1,3-dioxolane, 4-fluoro-1,3-dioxolane; 4,5-difluoro-1,3-dioxolane, or a mixture of any two or more thereof. In some embodiments, the fluorinated ether-based diluent includes 1,1,2,2-tetrafluoroethyl-2,2,3,3-tetrafluoropropyl ether (TTE), 1,2-(1,1,2,2-tetrafluoroethoxy)ethane (TFEE), 1,1,1-trifluoroethyl-2,2,3,3-tetrafluoropropyl ether (TFTFE), bis-(trifluoroethyl) ether (BTFE), or a mixture of any two or more thereof. In some embodiments, the fluorinated ether-based diluent includes 1,1,2,2-tetrafluoroethyl-2,2,3,3-tetrafluoropropyl ether (TTE).

Illustrative ether-based diluents include, but are not limited to, 1,3-dioxolane (DOL), dimethoxyethane (DME), tetrahydrofuran, di(ethylene glycol) dimethyl ether, tri(ethylene glycol) dimethyl ether, diglyme (DGM), partly silanized ether, tetra(ethylene glycol) dimethyl ether (TEGDME), poly (ethylene glycol) dimethyl ether (PEGDME), 1,4-dioxane, or a mixture of any two or more thereof. In some embodiments, the ether-based diluent includes dimethoxyethane (DME). In some embodiments, the diluent includes butanenitrile (BN). The diluent, in some embodiments, may also include a carbonated-based diluent, a fluorinated carbonate-based diluent, or a mixture of any two or more thereof.

Illustrative carbonated-based diluents include, but are not limited to, ethylene carbonate, dimethyl carbonate, ethyl methyl carbonate, diethyl carbonate, propylene carbonate, fluorinated carbonate, or a mixture of any two or more thereof. Illustrative fluorinated carbonated-based diluents include, but are not limited to, fluoroethylene carbonate (FEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, or a mixture of any two or more thereof. In some embodiments, the fluorinated carbonated-based diluent includes fluoroethylene carbonate (FEC). In some embodiment the diluent includes fluoroethylene carbonate (FEC) and butanenitrile (BN). In some embodiment the diluent includes fluoroethylene carbonate (FEC) and dimethoxyethane (DME).

In some embodiments, the diluent does not include a carbonated-based diluent, a fluorinated carbonated-based diluent, or a mixture of any two or more thereof. In some embodiments, the diluent does not include a carbonated-based diluent. In some embodiments, the diluent does not a fluorinated carbonated-based diluent.

The diluent may be present in the electrolyte in a solvent to diluent ratio of from about 50:50 to about 90:10, from about 50:50 to about 80:10, or from about 50:50 to about 75:25, including about 50:50, about 55:45, about 60:40, about 65:35, about 70:30, about 75:25, about 80:20, about 85:15, and about 90:10. In some embodiments, the diluent is present in the electrolyte in a solvent to diluent ratio of from about 50:50 to about 90:10. In some embodiments, the diluent is present in the electrolyte in a solvent to diluent ratio of from about 50:50 to about 80:10. In some embodiments, the diluent is present in the electrolyte in a solvent to diluent ratio of from 50:50 to about 75:25.

In some embodiments, the electrolyte may also include a stabilizing additive. In some embodiments, the stabilizing additive includes a N—O compound, polysulfide, phosphorus pentasulfide, fumaronitrile, ethyl 3,3,3-trifluoropropanoate (TFPE), vinylene carbonate (VC), fluoroethylene carbonate (FEC), ethylene sulfite (ES), p-toluenesulfonyl isocyanate (PSTI), triethylborate (TEB), tris(trimethylsilyl)borate(TMSB), tris(trimethylsilyl)phosphite (TMSPi), tris(2,2,2-trifluoroethyl)phosphite (TTFPi), tris(trimethylsilyl)borate (TMSB), phenyl vinyl sulfone (PVS), ethylene glycol bis(propionitrile)ether (EGBE), terthiophene (3THP), quercetin (Qc), or a mixture of any two or more thereof.

In some embodiments, the electrolyte further includes an additive including LiDFOB (lithium difluoro(oxalato)borate), LiDFMB (lithium difluoro(maleic)borate), LiBOB (lithium bis(oxalato)borate, LiTFOP (lithium tetrafluoro(oxalato)phosphate, LiTFMP (lithium tetrafluoro(maleic)phosphate LiDFOP (lithium difluoro-bis(oxalato)phosphate, LiTOP (lithium tri(oxalato)phosphate, or a mixture of any two or more thereof. In some embodiments, the electrolyte further includes LiDFOB (lithium difluoro(oxalato)borate).

### Electrochemical Devices

Examples of electrochemical devices include but are not limited to electric double-layer capacitor, secondary batteries, solar cells of the pigment sensitizer type, electrochromic devices, and condensers. Especially suitable electrochemical devices include electric double-layer capacitor and secondary batteries such as lithium ion battery.

Also provided in another aspect is an electrochemical device including:
(a) a cathode;
(b) an anode; and
(c) any one of the electrolytes described herein.

In some embodiments, the electrochemical device is a lithium or sodium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical device is an electrochemical cell such as a capacitor. In some embodiments, the capacitor is an asymmetric capacitor or supercapacitor. In some embodiments, the electrochemical cell is a primary cell. In some embodiments, the primary cell that is a lithium/MnO₂ battery or Li/poly(carbon monofluoride) battery. In some embodiments, the electrochemical cell is a solar cell.

Suitable cathodes include those such as, but not limited to, a lithium metal oxide, spinel, olivine, carbon-coated olivine, LiFePO₄, LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiMn₂O₄, LiFeO₂, Li_{1-x′}Ni_{α}Mn_{β}Co_{γ}Met′_{δ}O_{2-z′}F_{z′}, A_{n′}B₂(XO₄)₃ (NASICON), vanadium oxide; lithium peroxide, sulfur, polysulfide, a lithium carbon monofluoride (also known as LiCFx), or mixtures of any two or more thereof, where Met is Al, Mg, Ti, B, Ga, Si, Mn, or Co; Met′ is Mg, Zn, Al, Ga, B, Zr, or Ti; A is Li, Ag, Cu, Na, Mn, Fe, Co, Ni, Cu, or Zn; B is Ti, V, Cr, Fe, or Zr; X is P, S, Si, W, or Mo; 0≤x≤0.3, 0≤y≤0.5, 0≤z≤0.5; 0≤x′≤0.4, 0≤α≤1, 0≤β≤1, 0≤y≤1, 0≤ö≤0.4, and 0≤z′≤0.4; and 0≤n′≤3. According to some embodiments, the spinel is a spinel manganese oxide with the formula of Li₁₊ₓMn_{2-z}Met′″_{y}O₄₋ₘX′ₙ, wherein Met″′ is Al, Mg, Ti, B, Ga, Si, Ni, or Co; X′ is S or F; and wherein 0≤x≤0.3, 0≤y≤0.5, 0≤z≤0.5, 0≤m≤0.5 and 0≤n≤0.5. In other embodiments, the olivine has a formula of Li₁₊ₓFe_{1-z}Met″_{y}PO₄₋ₘX′ₙ, wherein Met″ is Al, Mg, Ti, B, Ga, Si, Ni, Mn or Co; X′ is S or F; and wherein 0≤x≤0.3, 0≤y≤0.5, 0≤z≤0.5, 0≤m≤0.5 and 0≤n≤0.5.

In some embodiments, the cathode comprises a layered lithium nickel cobalt manganese oxide, spinel lithium nickel manganese oxide, lithium iron phosphate, lithium cobalt oxide, lithium nickel oxide, lithium manganese oxide, or a mixture of any two of more thereof. In some embodiments, the cathode comprises lithium iron phosphate. In some embodiments, the cathode comprises layered lithium nickel cobalt manganese oxide, spinel lithium nickel manganese oxide, or a mixture of any two of more thereof.

For lithium secondary batteries, or cathodes to be used in lithium secondary batteries, the cathodic material may include either lithiated materials or surface coated lithiated materials. For example, such materials and composites include, but are not limited to, MnO₂, V₂O₅, LiVO₃, air (oxygen), FeF₂, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, Li₁₊ₓMn_{2-z}M⁴_{y}O₄₋ₘX¹n, LiFe_{1-z}M⁶_{y}PO₄₋ₘX¹ₙ, LiMn_{1/3}Co_{1/3}Ni_{1/3}O₂, LiMn₂O₄, LiFeO₂, LiM⁴_{0.5}Mn_{1.5}O₄, Li_{1-x′}Ni_{α}Mn_{β}Co_{γ}M⁵_{δ}O_{2-z′} both single composition or gradient composition, Li₂MnO₃-LiₐM_{b}M′_{c}M“_{d}Oₑ, Li_{n′}B¹₂ (M²O₄)₃ (Nasicon), Li₂MSiO₄, or a mixture of any two or more thereof, wherein M² is P, S, Si, W, or Mo; M⁴ is Al, Mg, Ti, B, Ga, Si, Ni, or Co; M⁵ is Mg, Zn, Al, Ga, B, Zr, or Ti; A is Li, Ag, Cu, Na, Mn, Fe, Co, Ni, or Zn; M⁶ is Al, Mg, Ti, B, Ga, Si, Ni, Mn or Co; M, M′, and M” are transition metals; B¹ is Ti, V, Cr, Fe, or Zr; X¹ is S or F; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤α≤1; 0≤β≤1; 0≤γ≤1; 0≤δ≤0.4; 0≤z″≤0.4; 0≤n′≤3; 0≤a+b+c+d≤6; 0≤e≤4; and 0≤α+β+γ+δ.

For sodium secondary batteries, or cathodes to be used in sodiated secondary batteries, the cathodic material may include either sodiated materials or surface coated sodiated materials. For example, such materials and composites include, but are not limited to a spinel, an olivine, a carbon-coated olivine, NaFePO₄, NaCoO₂, NaNiO₂, NaNi₁₋ₓCo_{y}M⁴_{z}O₂, NaMn_{0.5}Ni_{0.5}O₂, NaMn_{1/3}Co_{1/3}Ni_{1/3}O₂, NaMn₂O₄, NaFeO₂, NaM⁴_{0.5}Mn_{1.5}O₄, Na_{1-x″}Ni_{α}Mn_{β}Co_{γ}M⁵_{δ}O_{2-z″}F_{z″}, Na₂MnO₃-NaₐM_{b}M′_{c}M″_{d}Oₑ, Na_{n′}B¹₂ (M²O₄)₃ (Nasicon), Na₂MSiO₄, NaVPO₄F or a mixture of any two or more thereof, wherein M² is P, S, Si, W, or Mo; M⁴ is Al, Mg, Ti, B, Ga, Si, Mn, or Co; M⁵ is Mg, Zn, Al, Ga, B, Zr, or Ti; M, M′, and M″ are transition metals; B¹ is Ti, V, Cr, Fe, or Zr; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤δ≤1; 0≤β≤1; 0≤γ≤1; 0≤δ≤1; 0≤δ′≤0.4; 0≤z″≤0.4; 0≤n′≤3; 0≤a+b+c+d, and 0≤e.

The cathodic material may include, in some embodiments, a spinel, an olivine, or a carbon-coated olivine. For example, the cathodic material may be, according to an embodiment, a spinel manganese oxide of formula of Li₁₊ₓMn_{2-z}M⁴_{y}O₄₋ₘX¹ₙ, wherein M⁴ is Al, Mg, Ti, B, Ga, Si, Ni, or Co; X¹ is S or F; 0≤x≤0.3; 0≤y≤0.5; 0≤z≤0.5; 0≤m≤0.5; and 0≤n≤0.5. The cathodic material may be, according to an embodiment, an olivine of formula of LiFe_{1-z}M⁶_{y}PO₄₋ₘX¹ₙ or a mixture of any two or more such olivines; wherein M⁶ is Al, Mg, Ti, B, Ga, Si, Ni, Mn or Co; X¹ is S or F; 0≤x≤0.3; 0≤y≤0.5; 0≤z≤0.5; 0≤m≤0.5; and 0≤n≤0.5.

The cathodic material may include a blend of a spinel and Li_{1+x″}Ni_{α}Mn_{β}Co_{γ}M⁵_{δ}O_{2-z″}F_{z}, wherein M⁵ is Mg, Zn, Al, Ga, B, Zr, or Ti; 0≤x″≤0.4; 0≤α≤1; 0≤β≤1; 0≤γ≤1; 0≤δ≤0.4; 0≤z″≤0.4; 0≤α+β+γ+δ. The ratio of the spinel to the Li_{1+x″}Ni_{α}Mn_{β}Co_{γ}M⁵_{δ}O_{2-z″}F_{z″} may be from about 0.5 wt % to about 98 wt %. Alternatively, the cathode may include a blend of an olivine or a carbon-coated olivine, and Li_{1-x″}Ni_{α}Mn_{β}Co_{γ}M⁵_{δ}O_{2-z″}F_{z} wherein M⁵ is Mg, Zn, Al, Ga, B, Zr, or Ti; 0≤x″≤0.4; 0≤α≤1; 0≤β≤1; 0≤γ≤1; 0≤δ≤0.4; 0≤z″≤0.4; 0≤α+β+γ+δ. The ratio of the ratio of the olivine or carbon-coated olivine to the Li_{1-z″}Ni_{α}Mn_{β}Co_{γ}M⁵_{δ}O_{2-z″}F_{z} may be from about 0.5 wt % to about 98 wt %.

The cathodic material may include a non-lithiated or non-sodiated material such as MnO₂, V₂O₅, LiVO₃, MoS₂, FeS₂, S, organic cathode, air or oxygen cathode such as carbon, FeF₃, FeF₂, or a mixture of any two or more thereof. In other embodiments, the cathodic material includes sulfur. In some embodiments, the cathodic material is air (oxygen).

Where the cathode is for use in a sodium ion electrochemical cell, the cathodic material may include NaM₁₋ₓM′ₓPO₄, NaₓM_{y}M′_{z}O₂, Na₂FePO₄F, Na₂MnPO₄F, NaFeSO₄F, NaMnSO₄F, NaV_{1-α}Cr_{α}PO₄F, Na₂S, Na₂Se, or a mixture of any two or more thereof, wherein 0<x; 0<y+z; M is Mn, Ni, Fe, Co, or Cu; M′ is Cr or Mg; and 0≤α≤1.

The cathode may be further stabilized by surface coating the active particles with a material that can neutralize acid or otherwise lessen or prevent leaching of the transition metal ions. Hence the cathodes can also comprise a surface coating of a metal oxide or fluoride such as ZrO₂, TiO₂, ZnO₂, WO₃, Al₂O₃, MgO, SiO₂, SnO₂, A₁PO₄, Al(OH)₃, AlF₃, ZnF₂, MgF₂, TiF₄, ZrF₄, LiMPO₄ or LiMBO₃, where in M indicates transition metal such as but not limited to Ni, Mn, Co, or a mixture of any two or more thereof, or of any other suitable metal oxide or fluoride. The coating can be applied to a carbon-coated cathode. The cathode may be further stabilized by surface coating the active particles with polymer materials. Examples of polymer coating materials include, but not limited to, polysiloxanes, polyethylene glycol, or poly(3,4-ethylenedioxythio-phene) polystyrene sulfonate, a mixture of any two or more polymers. The cathode may be carbon-coated to improve the stability and conductivity via chemical or physical method. Examples of carbon coating includes but not limit to high-energy mixing, vapor phase deposition, plasma-assisted chemical vapor deposition (CVD), spraying, liquid-phase deposition, electrochemical deposition, plasma enhanced atomic layer deposition, calcination of carbon precursor, or other mechanical or chemical means.

The cathodes, or the cathode(s) of the secondary battery, also include a primary cathodic material. The primary cathodic material may include a lithiated positive active material, a non-lithiated positive active material, a sodiated positive active material, a non-sodiated positive active material, or a mixture of any two or more thereof. In some embodiments, the primary cathodic material may include a lithiated positive active material, a sodiated positive active material, or a mixture of lithiated and sodiated positive active material.

The primary cathodic material may include a positive active material that is configured to only insert, or de-insert lithium or sodium. For example, the positive active material may be configured to only insert, or de-insert lithium from about 1.5 V to about 5.0 V vs. lithium. Alternatively, the positive active material may be configured to only insert, or de-insert sodium from 1.2 to 5.0 V vs. sodium. As used herein, “insert” or “de-insert” is used to refer to the movement of either the lithium or sodium ion(s) into, or out of, respectively, the cathode material either through absorption, adsorption, intercalation, conversion, or alloying.

The cathode may include a current collector, a porous carbon (e.g. conductive) material, and/or a polymeric binder. The current collector may include copper, stainless steel, titanium, tantalum, platinum, gold, aluminum, nickel, cobalt-nickel alloys, highly alloyed ferritic stainless steel containing molybdenum and chromium; or nickel-, chromium-, or molybdenum-containing alloys. The current collector may be a foil, mesh, or screen, and the porous carbon material and optional metal oxide are contacted with the current collector by casting, pressing, or rolling the mixture thereto. The porous carbon material may include microporous carbon, mesoporous carbon, mesoporous microbeads, graphite, expandable graphite, carbon black, or carbon nanotubes. Commercial examples of carbon black include, but are not limited to, Super P, Black Pearl 2000, Denka Black, Vulcan XC72R, Ketjen black. The polymeric binder may include poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatin, or a copolymer of any two or more such polymers.

Suitable anodes include those such as lithium metal graphite, Li metal, Sb, Si, Si—C, SiO, Sn, tin oxide, Li₄Ti₅O₁₂, a composite tin alloy, a transition metal oxide, hard carbon soft carbon or a lithium metal nitride, phosphorous including black and red phosphorous, and phosphorous carbon composite; as well as doped phosphorus carbon with Sb, Si, Si—C, SiO, Sn, tin oxide, Li₄Ti₅O₁₂, a composite tin alloy, a transition metal oxide, or a lithium metal nitride or a mixture of any two or more. While the battery includes Li₂O, Li₂O₂, lithiated sulfur (including Li₂S), the Li₂O₂, Li₂O, and lithiated sulfur (including Li₂S), may be activated during the initial charges and supply lithium source for batteries. The Li₂O₂, Li₂O, and lithiated sulfur (including Li₂S) may supply lithium for the anode, and after discharge, the lithium is transmitted from anode to cathode, then supply for the cathode material during battery cycling. The Li₂O₂, Li₂O, and lithiated sulfur (including Li₂S) may compensate for the anode initial irreversible capacity loss and supply lithium to the cathode material, in case a non-lithiated cathode material is used. Suitable graphitic materials including natural graphite, artificial graphite, graphitized meso-carbon microbeads (MCMB), and graphite fibers, as well as any amorphous carbon materials.

In some embodiments, the anode comprises lithium metal, graphitic materials, amorphous carbon, Li₄T₁₅O₁₂, tin alloys, silicon or silicon alloys, intermetallic compounds, or mixtures of any two or more such materials. In some embodiments, the anode comprises silicon or silicon alloys.

In addition to the Li-ion storage active material, the anode may also include a current collector, a conductive carbon material, a binder, or any combination thereof. The anode current collector may be prepared from a wide variety of materials. For example, illustrative current collectors include, but are not limited to, carbon, copper, stainless steel, titanium, tantalum, platinum, palladium, gold, silver, iron, aluminum, nickel, rhodium, manganese, vanadium, titanium, tungsten, cobalt nickel alloy, highly alloyed ferritic stainless steel containing molybdenum and chromium; or nickel-, chromium-, or molybdenum-containing alloys, or a carbon-coated metal described above. The current collector may take the form of a foil, mesh, or screen. In some embodiments, the electroactive material disclosed herein and one or more of a conductive carbon material and a binder are contacted with the current collector by casting, pressing, or rolling the mixture thereto. In some embodiments, the current collector is copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

The current collectors may be in electrical contact with one another through an external circuit. The secondary battery may exhibit a jelly roll or stacked construction. A lithium source material (i.e., Li₂O₂) is incorporated on the positive electrode side or into the electrolyte.

In some embodiments, the anode and cathode are separated from each other by a porous separator. The separator for the lithium battery often is a microporous polymer film. Examples of polymers for forming films include: nylon, cellulose, nitrocellulose, polysulfone, polyacrylonitrile, polyvinylidene fluoride, polypropylene, polyethylene, polybutene, or co-polymers or blends of any two or more such polymers. In some instances, the separator is an electron beam treated micro-porous polyolefin separator. The electron treatment can improve the deformation temperature of the separator and can accordingly enhance the high temperature performance of the separator. Additionally, or alternatively, the separator can be a shut-down separator. The shut-down separator can have a trigger temperature above 130° C. to permit the electrochemical cells to operate at temperatures up to 130° C.

The electrochemical cells described herein may be used for various types of applications. For example, the secondary batteries may be used in portable electronics such as cell phones, laptop computers, and cameras, and in large power applications such in electric vehicles, hybrid electric vehicles, plug-in hybrid electric vehicles, and smart grids.

The present invention, thus generally described, will be understood more readily by reference to the following examples, which are provided by way of illustration and are not intended to be limiting of the present invention.

### Examples

### Materials and Methods

Electrochemical testing was performed on a MACCOR Series 4000 Automated Test System. 2032-coin cells were assembled using electrodes made by the Cell Analysis, Modeling, and Prototyping (CAMP) facility at Argonne National Laboratory. The cathode was made of 90 wt % LiFePO₄ (Johnson Matthey, Life Power P2 C—LiFePO₄), with 5 wt % C₄₅ carbon black (Timcal) and 5% PVDF binder (Solvay 5130) on a 20 μm aluminum current collector. The total active material loading was 17.73 mg/cm². The anode was composed of 80 wt % silicon (Paraclete nSiO), with 10 wt % C45, and 10 wt % Li-PAA on a 10 μm copper current collector. The total active material loading was 0.88 mg/cm². The electrodes were dried under vacuum at 110° C. (for cathodes) or 130° C. (for anodes) for at least 8 hours before use. All cells contained Celgard 2325 separators and were filled with 40 μL of electrolyte. For cycle life experiments, cells were initially cycled between 2.7 and 3.35V at a C/20 rate with a 24 hr constant voltage hold after three cycles. They were then cycled three times at a C/10 rate, 100 times at a C/3 rate, followed by three times at a C/10 rate. Calendar life experiments followed a previously established protocol, featuring three C/10 cycles, followed by an extended potentiostatic hold at the upper-cutoff voltage (UCV) for either 180 or 360 hrs.

The NMC811 cathode was made of 90 wt % NMC811 (Targrey, Product: SNMC03004), with 5 wt % C45 carbon black (Timcal) and 5% PVDF binder (Solvay 5130) on a 20 μm aluminum current collector. The total active material loading was 14.04 mg/cm².

Electrochemical impedance spectroscopy (EIS) characterization was carried out on a Solartron 1400 CellTest® System. The spectra were recorded in the frequency range from 1 MHz to 10 mHz with a 10 mV applied bias. Experiments were carried out at room temperature, in a coin cell format, with the cells brought to 20% state-of-charge (SOC) based on the discharge capacity of the previous cycle. Results are displayed for typical cells, rather than an average.

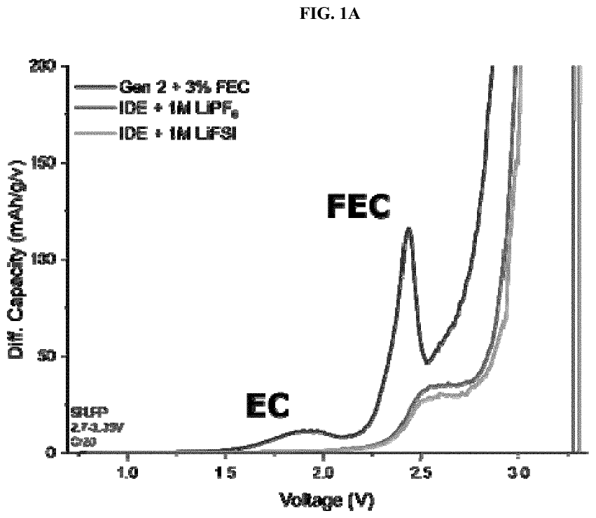

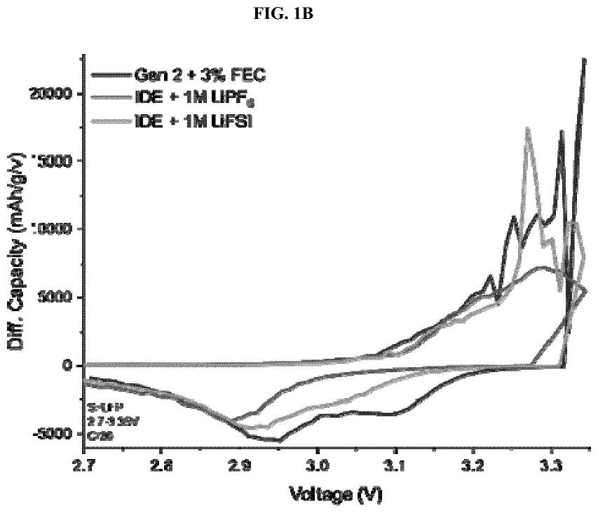

Example 1. FIGS. 1A and 1B illustrate the differential capacity curves of the first formation cycle for different electrolyte species: Gen 2+3% fluoroethylene carbonate (FEC), isosorbide dimethyl ether (IDE)+1 M LiPF₆, and IDE+1 M LiFSI focusing on solid electrolyte interphase (SEI) formation events (FIG. 1A) and overall lithiation profile (FIG. 1B). Gen 2 contains 1.2 M LiPF₆ in 3:7 ethylene carbonate/ethyl methyl carbonate, where the standard for silicon based anodes includes 3% or 10% (w/w) of fluoroethylene carbonate (FEC).

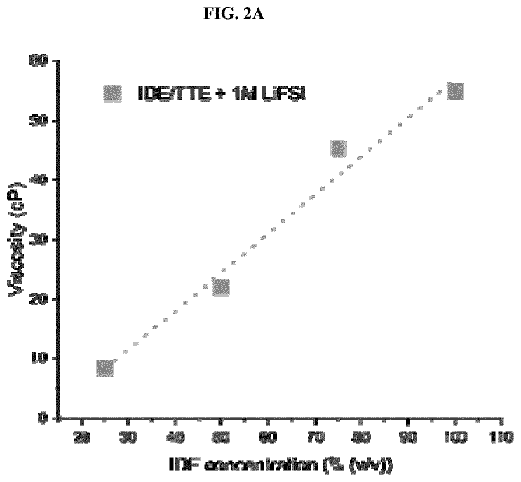

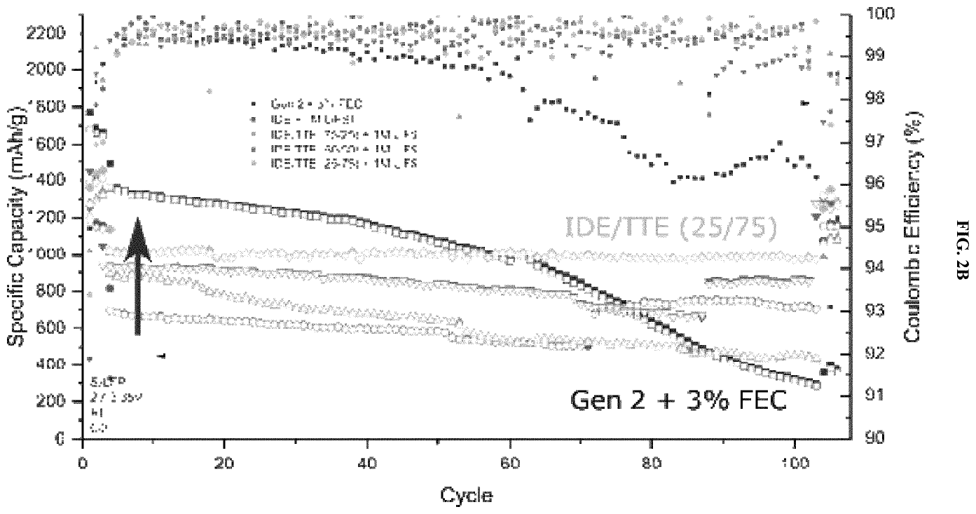

Example 2. FIG. 2A illustrates the change in viscosity with concentration of IDE in IDE/TTE electrolytes. FIG. 2B illustrates the specific capacity and Coulombic efficiency of IDE/TTE electrolytes (IDE+1 M LiFSI, IDE/TTE (75/25)+1 M LiFSI, IDE/TTE (50/50)+1 M LiFSI, and IDE/TTE (25/75)+1 M LiFSI) and on silicon anodes with lithium iron phosphate (LFP) cathodes. The comparative electrolyte was Gen 2, which contains 1.2 M LiPF₆ in 3:7 ethylene carbonate/ethyl methyl carbonate, with 3% w/w of fluoroethylene carbonate (FEC). TTE=1,1,2,2-tetrafluoroethyl-2,2,3,3-tetrafluoropropyl ether.

FIG. 2A shows that the addition of a diluent, such as TTE, lead to a lower viscosity and thus, increased starting discharge capacity.

FIG. 2B shows that the addition of a diluent, such as TTE, drastically improved discharge capacity. Despite temperature changes in the cycling room occurring regularly and potentially distorting the long term trend, FIG. 2B showed that increasing the amount of diluent increased the performance on silicon anodes, which is consistent with decreasing bulk impedance and is indicative of higher conductivity. The best performance was observed with IDE/TTE (25/75)+1M LiFSI.

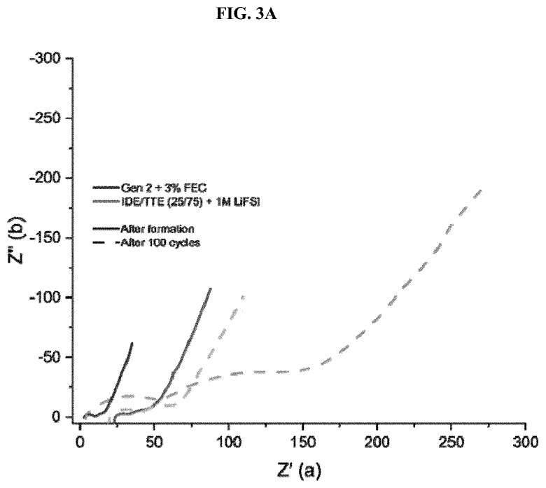

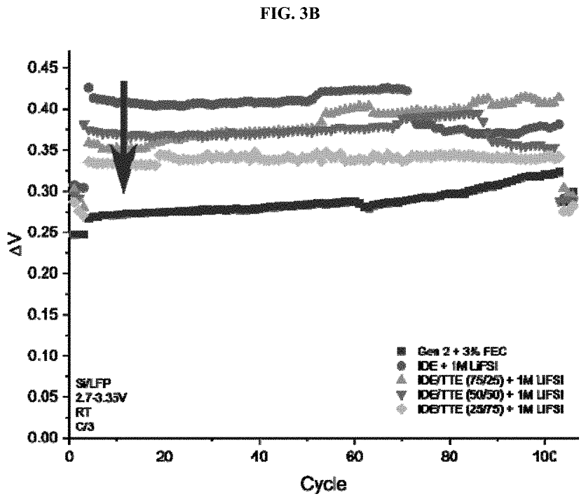

Example 3. FIG. 1A shows a Nyquist plot comparing cells with a carbonate-based electrolytes (Gen 2 containing 1.2M LiPF₆ in 3:7 ethylene carbonate/ethyl methyl carbonate with 3% w/w of fluoroethylene carbonate (FEC)) and an IDE-based electrolyte (IDE/TTE (25/75)+1 M LiFSI) after formation cycles, and after aging cycles on silicon anodes with lithium iron phosphate (LFP) cathodes. FIG. 3B illustrates the difference between average charge and discharge voltage for different electrolytes (IDE+1 M LiFSI, IDE/TTE (75/25)+1 M LiFSI, IDE/TTE (50/50)+1 M LiFSI, and IDE/TTE (25/75)+1 M LiFSI) during aging cycles of silicon anodes with lithium iron phosphate (LFP) cathodes. The comparative electrolyte used in this study was Gen 2, which contains 1.2M LiPF₆ in 3:7 ethylene carbonate/ethyl methyl carbonate, with 3% w/w of fluoroethylene carbonate (FEC).

FIGS. 3A and 3B show that for the comparative electrolyte, impedance significantly increases after cycling. In contrast, the impedance for the IDE/TTE electrolyte was nearly unchanged, consistent with its cycling performance. Similarly, the average difference between charge and discharge voltage remained mostly unchanged for the IDE/TTE electrolytes.

The effect of nonreactive IDE/TTE can also be seen by looking at the difference between the average charging voltage and the average discharging voltage (ΔV). This value will increase proportionally to the internal resistance of the cell, as the resistance will cause the voltage profiles to shift in the direction of current flow. In a perfect scenario this value will remain constant throughout the aging protocol. Unfortunately, in practice it generally increases decomposition from the electrolyte thickens interphases, active materials degrade, electrical contact is broken, etc.

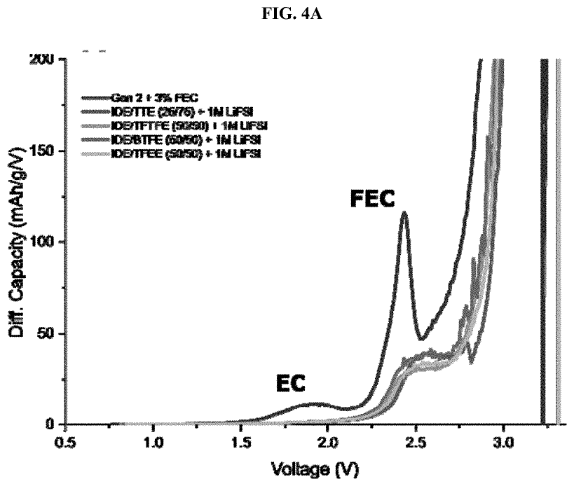

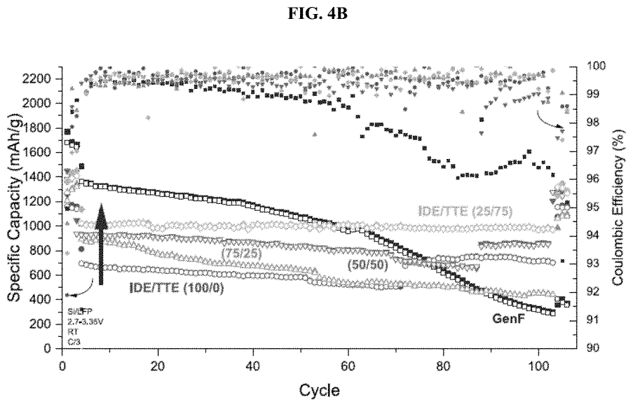

The effect of this can be clearly seen in FIG. 3B. GenF starts the C/3 cycling at a relatively low ΔV of 267 mV, which then slowly rises over the course of the experiment. This is proportional to the fall in capacity in FIG. 4B. The rise rapidly accelerates around cycle 60, coincident with the increasing drop in capacity and ends cycling with a ΔV of 323 mV. In contrast, the IDE/TTE electrolyte starts at higher values of ΔV, likely due to its still higher viscosity. There is a general trend of decreasing viscosity leading to lower starting values of ΔV, ranging from 426 mV for 100% IDE to 336 mV for IDE/TTE (25/75). However, all of the IDE-based electrolytes change very little in ΔV, outside of the shifts from the previously mentioned external temperature changes. This indicates that there is very little degradation occurring in the systems with an IDE/TTE electrolyte, regardless of the everchanging surface that is characteristic of the silicon anode.

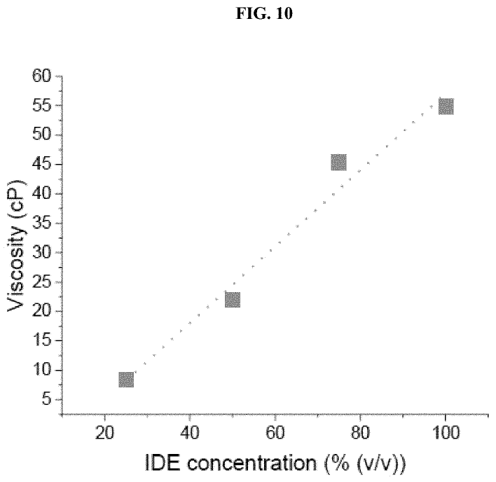

Example 4. FIG. 4A shows the differential capacity curves of silicon anodes with lithium iron phosphate (LFP) cathodes for different electrolytes: IDE/TTE (25/75)+1 M LiFSI, IDE/TFTFE (50/50)+1 M LiFSI, IDE/BTFE (50/50)+1 M LiFSI, IDE/TFEE (50/50)+1 M LiFSI). The comparative electrolyte used in this study was Gen 2, which contains 1.2 M LiPF₆ in 3:7 ethylene carbonate/ethyl methyl carbonate, with 3% w/w of fluoroethylene carbonate (FEC). FIG. 4B shows the specific capacities and Coulombic efficiencies of silicon anodes with lithium iron phosphate (LFP) cathodes for the electrolytes as described in FIG. 4A. TFEE=1,2-(1,1,2,2-tetrafluoroethoxy)ethane, TFTFE=1,1,1-trifluoroethyl-2,2,3,3-tetrafluoropropyl ether, and bis-(trifluoroethyl) ether (BTFE). 1,1,1-trifluoroethyl-1,1,2,2-tetrafluoropropyl ether (TTE) is itself stable to the silicon, while still leading to a significant decrease in viscosity. This decline in viscosity is nearly linear with increasing amounts of TTE (see FIG. 10), eventually declining to 8.4 cP at an IDE/TTE ratio of 25/75 in volume, which is near the saturation point with 1 M LiFSI. This value is still higher than the viscosity of GenF at 4.2 cP; thus, some decline in discharge capacity at higher C rates is expected.

Density functional theory (DFT) calculations show that IDE has a binding energy to the Li+ which is similar to that of ethylene carbonate (EC) but significantly stronger than that of TTE (Table 1), indicating that the solvation sheath with Li⁺ would be expected to contain mainly IDE, while TTE is nonsolvating and solely serves to decrease the viscosity. The lowest unoccupied molecular orbital (LUMO) for IDE is also 0.2 eV higher in energy than those of TTE or EC, which would make it less likely to be reduced on the silicon surface.

TABLE 1
Energy Calculations

| | Binding Energy | | |
|---|---|---|---|
| Component | (eV) | HOMO^{a} (eV) | LUMO^{b} (eV) |
| IDE | −2.048 | −6.928 | −0.111 |
| TTE | −1.304 | −9.871 | −0.383 |
| EC | −1.904 | −8.494 | −0.313 |

^{a}HOMO is the Highest Occupied Molecular Orbital.
^{b}LUMO is the Lowest Unoccupied Molecular Orbital.

The below table summarizes the results from FIGS. 4A and 4B and show that the electrolytes having IDE with a diluent have better capacity retention and Columbic efficiency as compared to the comparative electrolyte Gen 2+3% FEC.

| | Capacity | Avg. | |
|---|---|---|---|
| | Retention | Coulombic | Change in |
| Electrolyte | (C/10) | Efficiency | ΔV (mV |
| Gen 2 + 3% FEC | 24.6% | 97.39% | 43 |
| IDE/TTE (25/75) + 1M LiFSI | 93.5% | 99.68% | 6 |
| IDE TFEE (50/50) + 1M | 95.1% | 99.84% | 4 |
| LiFSI | | | |
| IDE/TFTFE (50/50) + 1M | 101.6% | 99.76% | −15 |
| LiFSI | | | |
| IDE/BTFE (50/50) + 1M | 94.6% | 99.83% | −7 |
| LiFSI | | | |

With regard to FIG. 4B, decreasing the viscosity with added TTE leads to a predictable increase in starting discharge capacity in comparison to the highly viscous IDE solo electrolytes. At C/3 this increase is nearly linear, rising from the 696 mAh/gSi for IDE alone to 1023 mAh/gSi for IDE/TTE (25/75), while the CE remains constant at 99.7%. While this discharge capacity is still well short of that of GenF, the increased stability of IDE more than compensates after 100 cycles, when the IDE/TTE (25/75) has a capacity retention of 90%, in comparison to GenF at 22%. This stable capacity retention and CE for all IDE/TTE electrolytes indicates that the TTE is not changing the stability of the electrolyte, as is seen for LHCEs. Instead, the decreased viscosity caused by the increasing proportion of TTE improves the conductivity, thus allowing the electrolyte to utilize more of the silicon active material.

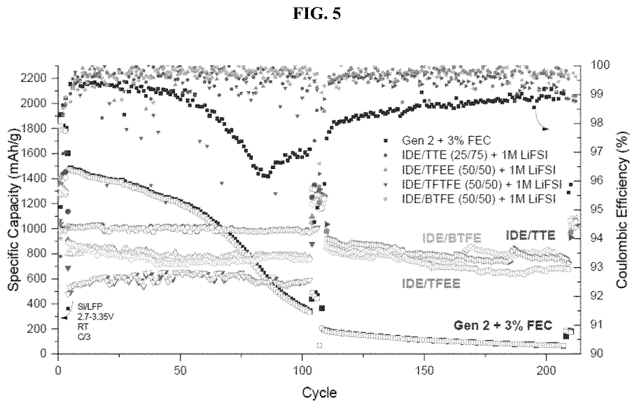

Example 5. FIG. 5 shows the specific capacities and Coulombic efficiencies after extended cycling of silicon anodes with lithium iron phosphate (LFP) cathodes for different electrolytes: IDE/TTE (25/75)+1 M LiFSI, IDE/TFTFE (50/50)+1 M LiFSI, IDE/BTFE (50/50)+1 M LiFSI, and 1 M LiFSI, IDE/TFEE (50/50)+1 M LiFSI. The comparative electrolyte used in this study was Gen 2, which contains 1.2M LiPF₆ in 3:7 ethylene carbonate/ethyl methyl carbonate, with 3% w/w of fluoroethylene carbonate (FEC).

FIG. 5 shows that even after extended cycling, the electrolytes having IDE with a diluent have better capacity retention and Columbic efficiency as compared to the comparative electrolyte Gen 2+3% FEC.

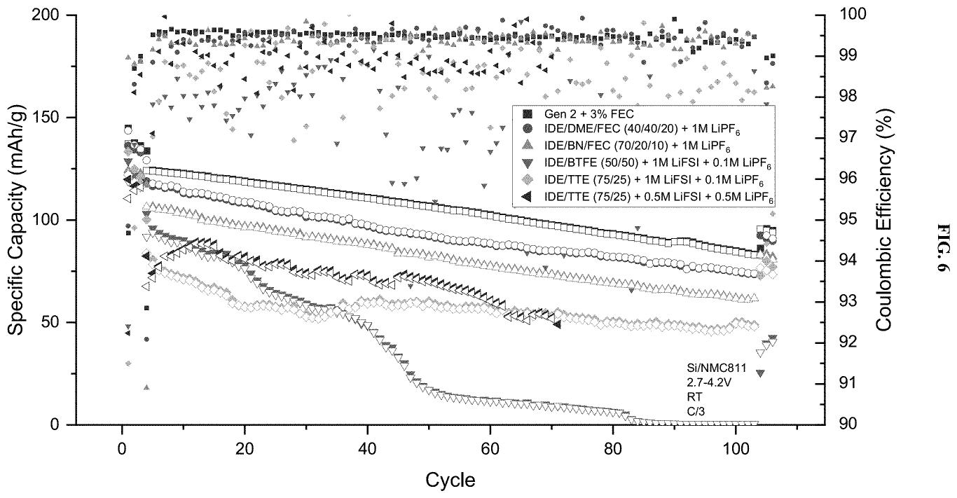

Example 6. FIG. 6 shows the specific capacities and Coulombic efficiencies of silicon anodes with LiNi_{0.8}Mn_{0.1}Co_{0.1}O₂ (NMC811) cathodes for different electrolytes: IDE/DME/FEC (40/40/20)+1 M LiPF₆, IDE/BN/FEC/(70/20/10)+1 M LiPF₆, IDE/BTFE (50/50)+1 M LiFSI+0.1 M LiPF₆, IDE/TTE (75/25)+1 M LiFSI+0.1 M LiPF₆, and IDE/TTE (75/25)+0.5 M LiFSI+0.5 M LiPF₆. The comparative electrolyte used in this study was Gen 2, which contains 1.2 M LiPF₆ in 3:7 ethylene carbonate/ethyl methyl carbonate, with 3% w/w of fluoroethylene carbonate (FEC). BN=butanenitrile, and DME=dimethoxyethane.

FIG. 6 shows that the electrolytes having LiPF₆, such as IDE/DME or IDE/BN have a performance consistent with the comparative electrolyte Gen 2+3% FEC. Electrolytes having LiFSI failed rapidly even with up to 0.5 M LiPF₆ to reduce corrosion.

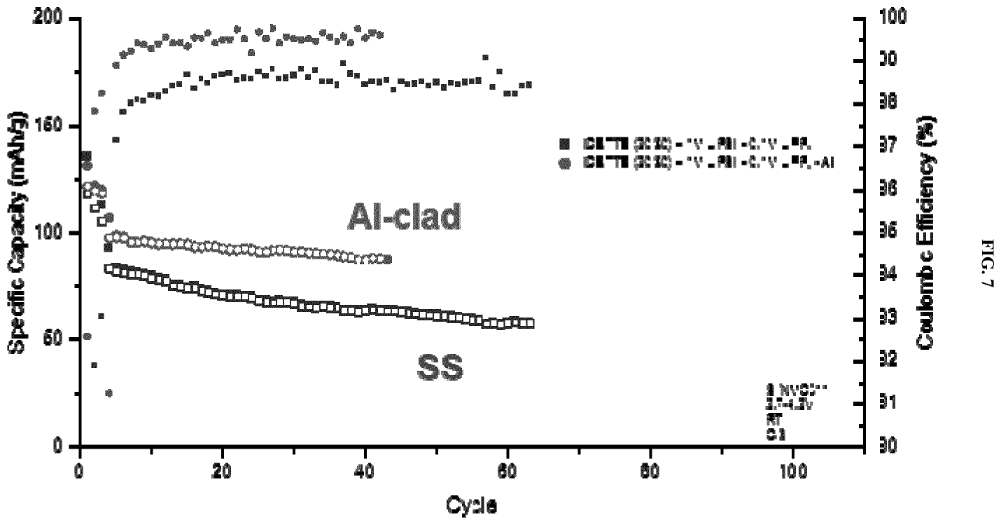

Example 7. FIG. 7 shows the specific capacities and Coulombic efficiencies of silicon anodes with LiNi_{0.8}Mn_{0.1}Co_{0.1}O₂ (NMC811) cathodes for different electrolytes: IDE/TTE (20/80)+1 M LiFSI+0.1 M LiPF₆ with stainless steel-free (SS) set up and IDE/TTE (20/80)+1 M LiFSI+0.1 M LiPF₆ with Al-clad cap.

While CV testing indicated that stainless steel was being passivated; FIG. 7 shows that switching to a stainless steel (SS) free setup improved performance dramatically. Additional studies also showed that a typical half-cell without active material, we've found that at 4.3V vs Li, corrosion currents are ˜0.7 μA after 1 hr, compared to ˜0.3 μA for comparative electrolyte Gen 2+3% FEC.

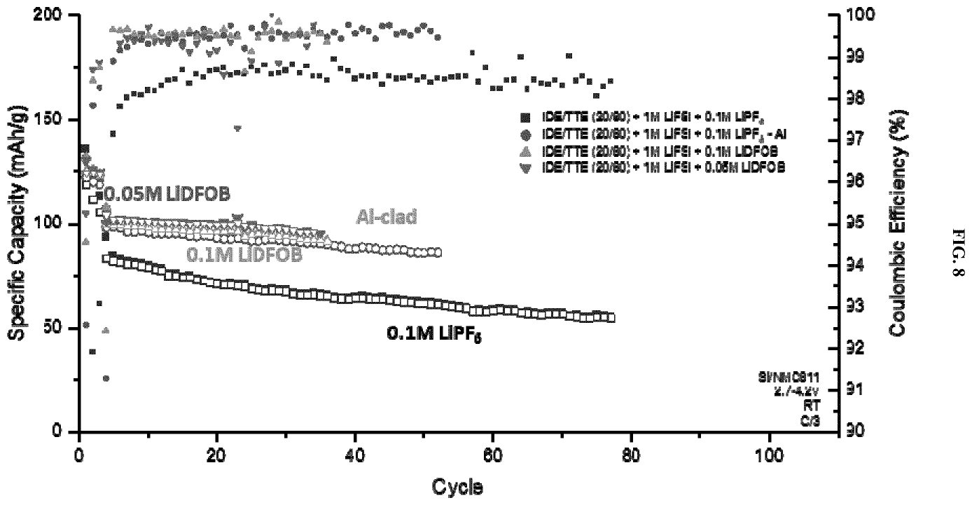

Example 8. FIG. 8 shows the specific capacities and Coulombic efficiencies of silicon anodes with LiNi_{0.8}Mn_{0.1}Co_{0.1}O₂ (NMC811) cathodes for different electrolytes: IDE/TTE (20/80)+1 M LiFSI+0.1 M LiPF₆, IDE/TTE (20/80)+1 M LiFSI+0.1 M LiPF₆ with Al-clad cap, IDE/TTE (20/80)+1 M LiFSI+0.1 M LiDFOB, and IDE/TTE (20/80)+1 M LiFSI+0.5 M LiDFOB.

FIG. 8 shows that as little as 0.05M LiDFOB is enough to stabilize performance in a Si/NMC811 cell at 4.2V. This corresponds to potentiostatic holds, where LiDFOB drastically reduces corrosion currents.

Example 9. For the purposes of this study, LiFePO₄ (LFP) was chosen as the positive electrode, with a loading such that the n:p ratio of the cell is less than 1. The flat voltage profile allows the silicon negative electrode to be fully lithiated to about 120 mV, and the low upper-cutoff voltage (UCV) of 3.35 V and high stability of the LFP will allow an assumption that any degradation is from reactions with the silicon itself. This contrasts with a lithium metal counter electrode, which introduces its own reactivity. Due to this full utilization of the silicon, discharge capacities are given relative to the amount of silicon in the electrode.

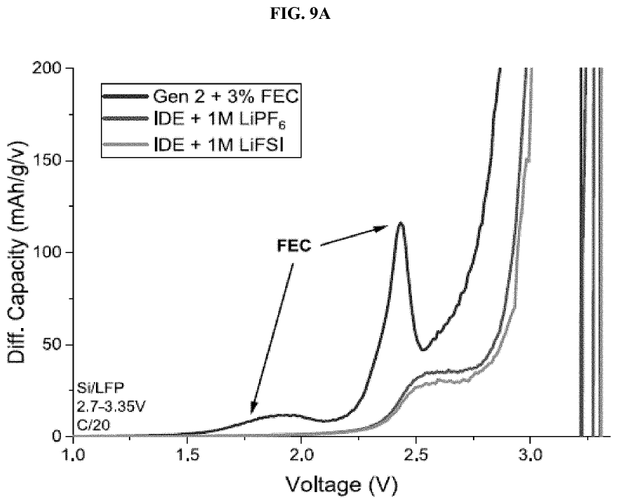

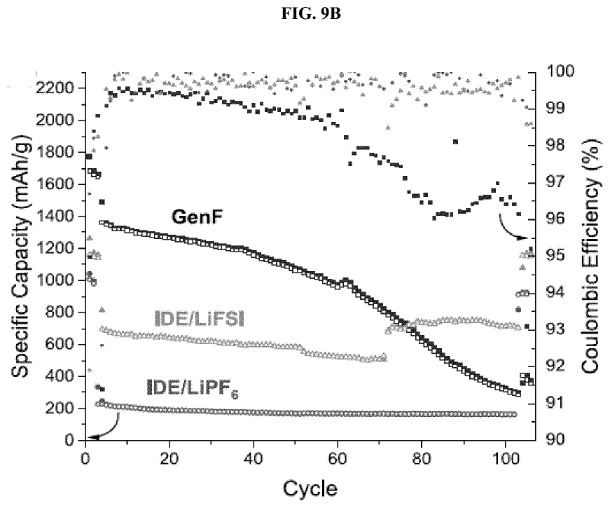

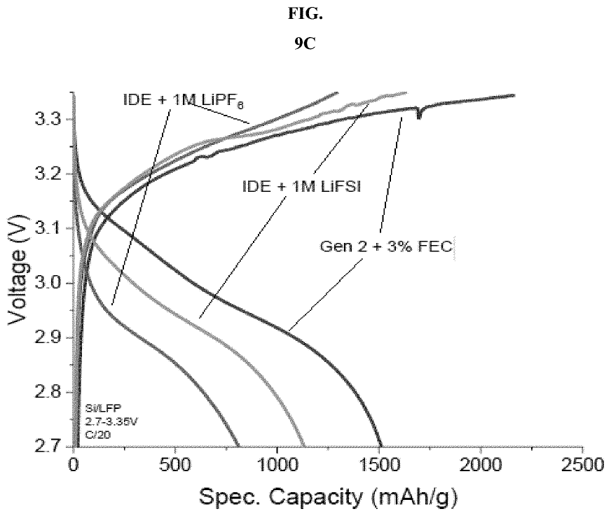

Early in the first cycle of the LFP/Si cell, electrolyte components susceptible to reduction will react with the Si negative electrode, forming a solid-electrolyte interphase (SEI) that insulates the electrolyte from further reactions. In FIG. 9A, a differential capacity plot (dQ/dV) of this early phase is shown, highlighting the electrochemical reduction reactions that contribute to the formation of this interphase. For the baseline electrolyte GenF (a mixture of ethylene carbonate (EC) and ethyl methyl carbonate (EMC) dissolved with 1.2 M LiPF6+3% (w/w) of fluoroethylene carbonate (FEC)), these signals are easily visible. There are two main peaks, a sharp signal at 2.43 V and a broader peak at 1.93 V, both of which have previously been assessed to correspond to the reduction of FEC. No other signals are visible, as the FEC is reduced prior to other components of the electrolyte. In contrast, two electrolytes based on IDE show very little in the way of SEI-forming species. The dQ/dV plot shows only a shoulder starting at 2.50 V, which only corresponds to the beginning of the lithiation process of the silicon anode.

FIG. 9C illustrates the various voltage profiles for these electrolytes. The charging profile is a slowly flattening plateau, beginning at around 3.0 V and continuing to flatten until reaching the UCV. The discharge profile is well defined with a broad slope beginning at 3.15 V and a flatter plateau beginning at 2.95 V. The baseline electrolyte GenF maintained a first-cycle discharge capacity of 1511 mAh/gSi and a firstcycle Coulombic efficiency (CE) of 69.8%. This is similar to what can be obtained from a lithium/Si half-cell in the equivalent voltage range, further supporting the efficacy of using LFP as a positive electrode. The voltage profiles for the IDE/LiPF6 and IDE/LiFSI electrolytes show a significant overpotential relative to GenF, which is particularly evident during the discharge step. Here, the overpotential is large enough to miss the second plateau seen in the GenF electrolyte, leading to a discharge capacity of 812 mAh/gSi and a CE of 62.6% for 1 M LiPF6 and 1133 mAh/gSi and 69.3% for 1 M LiFSI, respectively.

A difference in the electrolytes was visible during the cell assembly, as the IDE electrolytes, particularly that using LiPF6 as the salt, were significantly more viscous than the GenF electrolyte. Their wetting properties were also much worse and did not improve upon use of glass-fiber separators. Such a high viscosity would be expected to cause a low conductivity, which might lead to decreased performance relative to GenF upon increasing the current density. For this reason, we performed a cycle life test at C/3 to test the cycling stability of the three electrolytes at higher current densities. See FIG. 9B.

After three C/10 cycles, GenF has a discharge capacity of 1645 mAh/gSi, which drops to 1362 mAh/gSi when the cycling rate is increased to C/3. The discharge capacity and CE then slowly fall, with the decline accelerating around cycle 60. By the 100th cycle, the discharge capacity has declined to 284 mAh/gSi and the CE has dropped to 96.2%. Returning to C/10 barely increases the discharge capacity, establishing that the decline was due to lithium inventory consumption caused by the reaction of the electrolyte with the continually expanding and contracting silicon surface.

The IDE electrolytes show very different behavior. IDE+1 M LiFSI has a discharge capacity of 1139 mAh/gSi after three C/10 cycles, dropping to 696 mAh/gSi on an increase to C/3. This is consistent with the high viscosity of the electrolyte, which will respond more severely to higher C rates. Unfortunately, an external temperature change around cycle 68 artificially increased the discharge capacity, masking what the final outcome would be. What can be noted is the overall steady performance and the return to nearly the original discharge capacity upon returning to C/10 cycling. This supports the conclusion that IDE is relatively stable to the silicon surface. This can also be seen in the elevated CE, which averages 99.7% over the last 50 cycles, in comparison to GenF at 97.3%. A similar set of results can be seen for IDE+1 M LiPF6, which exhibits a more severe capacity drop to 227 mAh/gSi due to its higher viscosity but still shows a high capacity retention of 93.6% and an average CE of 99.9%.

From this set of results, it can be concluded that IDE does show a very high stability to lithiated silicon, on the basis of the extremely high capacity retention and Coulombic efficiency relative to GenF. However, the capacity at higher current densities is impractically low, due to the high viscosity of the IDE solo electrolyte, and will need to be improved to make a useful battery system.

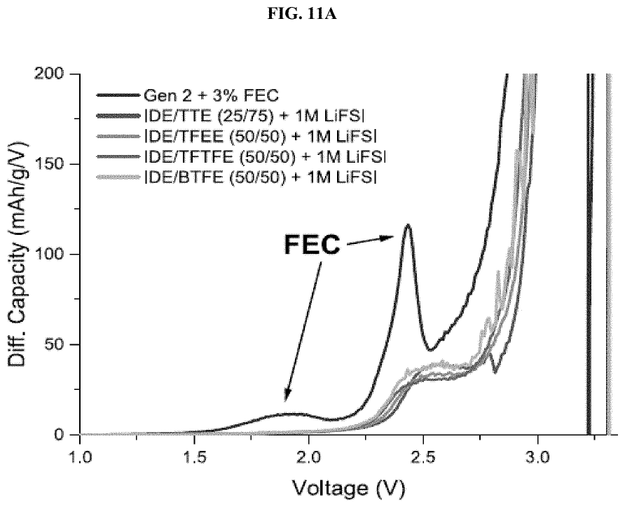

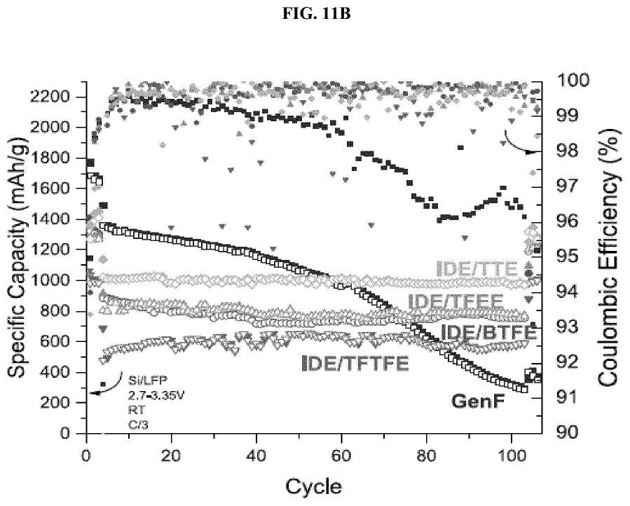

Example 10. Effect of Hydrofluoroether (HFE) Diluents. To determine if IDE/TTE pairing is unique, a variety of other HFEs were tested, including bis(2,2,2-trifluorethyl)ether (BTFE), 1,1,2,2-tetrafluoroethyl-2,2,2-trifluoroethyl ether (TFTFE), and 1,2-bis(2,2,3,3- tetrafluoroethoxy)ethane (TFEE). These HFEs were chosen to explore the effect of fluorinated structure on any interaction with the silicon surface. TFTFE includes a trifluoromethyl functionality, while maintaining the O—CH₂—CFx group that may be reactive to the silicon surface. TFEE abandons this functionality entirely, while changing to a glyme structure that may participate in Li+ solvation. BTFE, on the other hand, abandons the —CF₂H functionality entirely. The electrolytes were all made in a 50/50 ratio with IDE, as our interest is in their stability to silicon, not their viscosity. The dQ/dV plot for the first charge of the cells shows very little difference between the electrolytes in terms of their SEI forming peaks, particularly in comparison to GenF (FIG. 11A). This implies that, regardless of their structural conformation, none of the HFEs react with the silicon surface to form a discrete peak in the dQ/dV plor. The similarity continues, as all IDE/HFE electrolytes have the same shoulder starting around 2.50 V and nearly identical curves up through the first lithiation event. Upon the start of C/3 cycling, there is a difference in conductivity between the electrolytes, as would be expected (FIG. 11B). This can be easily seen from the starting discharge capacity, which is 804 mAh/gSi for TFEE, 885 mAh/gSi for BTFE, and 479 mAh/gSi for TFTFE. The order of conductivity, presumably caused by differences in viscosity, therefore seems to be BTFE>TFEE>>TFTFE. Despite these starting differences, all of the electrolytes ended up with very similar performances with regard to capacity retention and CE, indicating that using IDE as a lithium-coordinating solvent is generally compatible with any cosolvent that has stability with silicon.

Example 11. Improved Safety of IDE Electrolyte. One of the dangers in using carbonate solvents is their high flammability. As an example, ethyl methyl carbonate (EMC) has a flash point of 23° C. at room temperature, which makes these solvents a hazard when they are combined with the energy-releasing potential of Li0 on exposure to air. By comparison, IDE has a flash point of 110° C., which makes it a noncombustible liquid. As well, TTE and its HFE analogues have been shown to have flameextinguishing properties, and it can be hypothesized that such an IDE/TTE combination would have enhanced safety of the battery. When cotton swabs were soced with GenF electrolytes, they quickly caught on fire and burned steadily for nearly 30 seconds. In contrast, an identical swab soaked in the IDE/TTE (25/75)/LiFSI electrolyte barely ignited at all. The flame was rapidly suppressed, and while residual heat scorched the cotton, no continuing flammability was observed indicating that IDE/TTE is not only a stable electrolyte for silicon anodes but exhibits improved cell safety.

The above experimental results show that isosorbide-based electrolytes, such as those containing isosorbide dimethyl ether, are highly stable to Si-based anodes and can maintain the performance of silicon for much longer than the standard carbonate-based electrolytes. For example, the isosorbide-based electrolytes showed a capacity retention on Si/LFP cells of 101%, compared to 26% for the comparative carbonate-based electrolyte. The addition of a diluent, such as a fluorinated ether, to these isosorbide-based electrolytes were found to improve the discharge capacities while maintaining excellent capacity retention on Si/LFP cells by alleviating the high viscosity of the isosorbide-based electrolytes. Furthermore, additional studies have shown that the calendar life leakage currents eventually reach below the limit of detection for the isosorbide-based electrolytes.

In addition to being compatible with LFP cathodes, the isosorbide-based electrolytes described herein are also compatible with NMC cathodes. While corrosion was found to be a significant concern in full cell configurations, it was found that the addition of LiDFOB to isosorbide-based electrolytes enable stable cycling on Si/NMC811 cells.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure. Other embodiments are set forth in the following claims.

What is claimed is:

1. An electrolyte comprising:
(a) a lithium salt; and
(b) a solvent represented as a compound of Formula I: 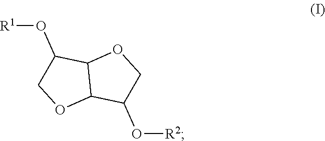
wherein,
R¹ and R² are each independently alkyl, haloalkyl, cycloalkyl, aryl, heteroaryl, aralkyl, heteroaralkyl, -L¹-OR³, —(C═O)—R⁴, —SO₂-R⁵, or —SO₂—OR⁵;
L¹ is alkylene; and
R³, R⁴, and R⁵ are each independently alkyl, haloalkyl, cycloalkyl, aryl, heteroaryl, aralkyl, or heteroaralkyl; and
(c) optionally, a diluent.

2. The electrolyte of claim 1, wherein R¹ and R² are each independently alkyl, haloalkyl, aryl, heteroaryl, -L¹-OR³, —(C═O)—R⁴, or —SO₂—OR⁵.

3. The electrolyte of claim 1, wherein R³, R⁴, and R⁵ are each independently alkyl or haloalkyl.

4. The electrolyte of claim 1, wherein R¹ and R² are each independently —CH₃, —CH₂CH₃, —CH₂CH₂CH₃, —CH₂CH₂CH₂CH₃, —CH(CH₃)₂, —C(CH₃)₃, —CF₃, —CH₂CF₃, —CF₂CF₃, or —CF₂CHF₂.

5. The electrolyte of claim 1, wherein R¹ and R² are not both —CH₃.

6. The electrolyte of claim 1, wherein R¹ and R² are each independently -(L¹)-OCH₃, -(L¹)-OCH₂CH₃, -(L¹)-OCH₂CH₂CH₃, -(L¹)-OCH₂CH₂CH₂CH₃, -(L¹)-OCH(CH₃)₂, -(L¹)-OC(CH₃)₃, -(L¹)-OCF₃, -(L¹)-OCH₂CF₃, -(L¹)-OCF₂CF₃, or -(L¹)-OCF₂CHF₂.

7. The electrolyte of claim 6, wherein L¹ is —CH₂—, —CH₂CH₂—, —CH₂CH₂CH₂— or —CH₂CH₂CH₂CH₂—.

8. The electrolyte of claim 1, wherein R¹ and R² are each independently —(C═O)—CH₃, —(C═O)—CH₂CH₃, —(C═O)—CH₂CH₂CH₃, —(C═O)—CH₂CH₂CH₂CH₃, —(C═O)—CH(CH₃)₂, —(C═O)—C(CH₃)₃, —(C═O)—CF₃, —(C═O)—CH₂CF₃, —(C═O)—CF₂CF₃, or —(C═O)—CF₂CHF₂.

9. The electrolyte of claim 1, wherein R¹ and R² are each independently —(SO₂)—OCH₃, —(SO₂)—OCH₂CH₃, —(SO₂)—OCH₂CH₂CH₃, —(SO₂)—OCH₂CH₂CH₂CH₃, —(SO₂)—OCH(CH₃)₂, —(SO₂)—OC(CH₃)₃, —(SO₂)—OCF₃, —(SO₂)—OCH₂CF₃, —(SO₂)—OCF₂CF₃, or —(SO₂)—OCF₂CHF₂.

10. The electrolyte of claim 1, wherein R¹ and R² are each independently phenyl, 2-pyridyl, 3-pyridyl, 4-pyridyl, 2-thienyl, 3-thienyl, 2-furyl, 3-furyl, 2-pyrrolyl, or 3-pyrrolyl.

11. The electrolyte of claim 1, wherein the solvent is a compound selected from the group consisting of:

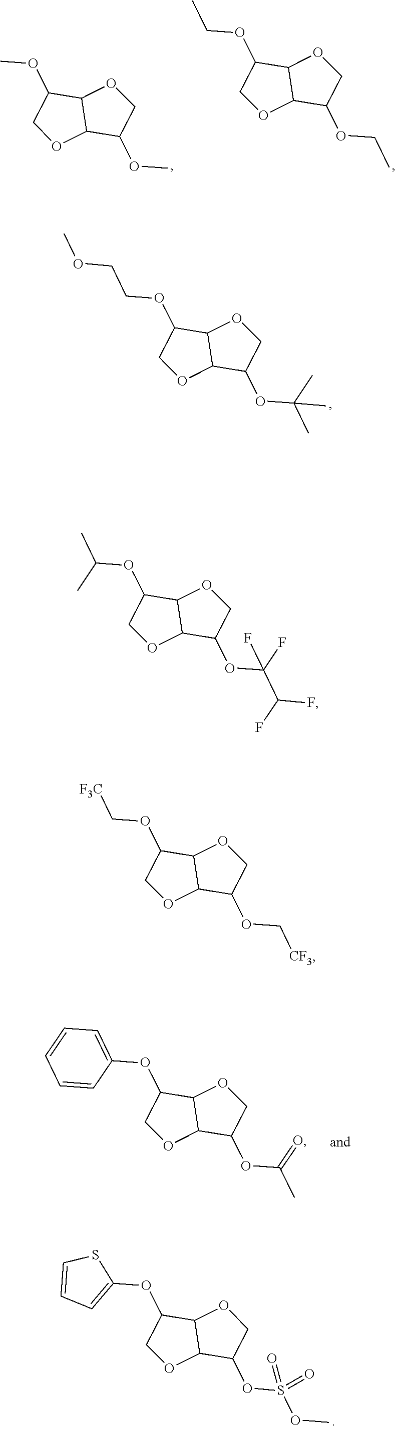

12. The electrolyte of claim 1, wherein the lithium salt comprises LiClO₄, LiPF₆, LiAsF₆, LiBF₄, LiB(C₂O₄)₂ (LiBOB), LiBF₂(C₂O₄) (LiDFOB), LiCF₃SO₃, LiN(SO₂F)₂ (LiFSI), LiPF₃(C₂F₅)₃ (LiFAP), LiPF₄(CF₃)₂, LiPF₃(CF₃)₃, LiN(SO₂CF₃), LiCF₃CO₂, LiC₂F₅CO₂, LiPF₂(C₂O₄)₂ (LiDFOP), LiP(C₂O₄)₃ (LiTOP), LiPF₄C₂O₄ (LiTFOP), LiPF₄(C₄H₂O₄) (LiTFMP), LiBF₂(C₄H₂O₄)₂ (LiDFMP), LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10.

13. The electrolyte of claim 1, wherein the lithium salt is present in the electrolyte in a concentration of from about 0.01 M to about 5 M or from about 0.01 M to about 1.5 M.

14. The electrolyte of claim 1, wherein the diluent is present and comprises a fluorinated ether-based diluent, an ether-based diluent, a nitrile-based diluent, or a mixture of any two or more.

15. The electrolyte of claim 1, wherein the diluent is present and comprises 1,1,2,2-tetrafluoroethyl-2,2,3,3-tetrafluoropropyl ether (TTE), 1,2-(1,1,2,2-tetrafluoroethoxy)ethane (TFEE), 1,1,1-trifluoroethyl-2,2,3,3-tetrafluoropropyl ether (TFTFE), bis-(trifluoroethyl) ether (BTFE), 1,3-dioxolane (DOL), dimethoxyethane (DME), tetrahydrofuran, di(ethylene glycol) dimethyl ether, tri(ethylene glycol) dimethyl ether, diglyme (DGM), partly silanized ether, tetra(ethylene glycol) dimethyl ether (TEGDME), poly (ethylene glycol) dimethyl ether (PEGDME), 1,4-dioxane, butanenitrile (BN), or a mixture of any two or more thereof.

16. The electrolyte of claim 1, wherein the diluent is present in the electrolyte in a solvent to diluent ratio of from about 50:50 to about 90:10.

17. An electrochemical device comprising:
(a) a cathode;
(b) an anode; and
(c) the electrolyte of claim 1.

18. The electrochemical device of claim 17, wherein the electrochemical device is a lithium or sodium secondary battery.

19. The electrochemical device of claim 17, wherein the cathode comprises a layered lithium nickel cobalt manganese oxide, spinel lithium nickel manganese oxide, lithium iron phosphate, lithium cobalt oxide, lithium nickel oxide, lithium manganese oxide, or a mixture of any two of more thereof.

20. The electrochemical device of claim 17, wherein the cathode comprises lithium iron phosphate, a layered lithium nickel cobalt manganese oxide, a spinel lithium nickel manganese oxide, or a mixture of any two of more thereof.
